(19) United States
(12) Patent Application Publication
(10) Pub. No.: US 2025/0112320 A1
(43) Pub. Date: Apr. 3, 2025

(54) BATTERY

(71) Applicant: MURATA MANUFACTURING CO., LTD., Kyoto (JP)

(72) Inventors: Daiki NISHIIE, Kyoto (JP); Yoshiichi HORIKOSHI, Kyoto (JP)

(21) Appl. No.: 18/827,135

(22) Filed: Sep. 6, 2024

(30) Foreign Application Priority Data
Sep. 29, 2023 (JP) 2023-170380

(51) Int. Cl. H01M 50/342; H01M 50/107

(52) U.S. Cl. CPC H01M 50/3425; H01M 50/107

(57) ABSTRACT

A battery is provided and including an exterior body that houses a battery assembly and an electrolyte, and a safety valve attached to the exterior body, wherein the battery assembly includes a positive electrode, a negative electrode, and a separator, the exterior body includes a cylindrical portion, a support portion protruding inward from the cylindrical portion at one end portion of the cylindrical portion, and an opening surrounded by the support portion, the safety valve is positioned at the one end portion of the cylindrical portion, and the safety valve and the support portion are fixed to each other with a thermoplastic resin layer interposed therebetween.

### CROSS REFERENCE TO RELATED APPLICATIONS

The present application claims priority to Japanese patent application no. 2023-170380, filed on Sep. 29, 2023, the entire contents of which are incorporated herein by reference.

### BACKGROUND

The present application relates to a battery.

A battery is capable of extracting energy generated through chemical change or the like as electric energy, and is used for various applications. For example, batteries are used in mobile devices such as mobile phones, smart phones, and notebook computers.

### SUMMARY

The present application relates to a battery. The present application particularly relates to a battery including a battery assembly including a positive electrode, a negative electrode, and a separator.

In a battery, a mechanism for ensuring the safety can be provided.

For example, a battery including a safety mechanism using a safety valve for suppressing occurrence of a defect caused by gas generated inside the battery when an abnormality has occurred in the battery is considered. There is still room for development of a safety valve capable of achieving current cutoff or the like at the time of abnormality.

The present application, in an embodiment, relates to providing a battery including a more suitable structure as a safety valve.

A battery according to an embodiment of the present application includes:
an exterior body that houses a battery assembly and an electrolyte; and
a safety valve attached to the exterior body, wherein the battery assembly includes a positive electrode, a negative electrode, and a separator,
the exterior body includes a cylindrical portion, a support portion protruding inward from the cylindrical portion at one end portion of the cylindrical portion, and an opening surrounded by the support portion,
the safety valve is positioned at the one end portion of the cylindrical portion, and
the safety valve and the support portion are fixed to each other with a thermoplastic resin layer interposed therebetween.

In the battery according to an embodiment of the present application, the safety valve is disposed outside the exterior body. The exterior body and the safety valve are fixed by a thermoplastic resin layer interposed between the exterior body and the safety valve. Such a structure makes it possible to release gas inside the battery to the outside by cleaving a fixed portion formed of the thermoplastic resin when the temperature of the battery increases and gas is abnormally generated inside the battery. This makes it possible to suppress or avoid the rupture of the battery in which the internal pressure has abnormally increased due to the generation of gas, and to safely cope with the abnormality.

### BRIEF DESCRIPTION OF THE FIGURES

FIG. 1 is a schematic perspective view illustrating an appearance of a battery according to an embodiment of the present application;

FIG. 2 is a schematic diagram illustrating an internal configuration of the battery according to an embodiment of the present application;

FIG. 3 is a schematic perspective view illustrating constituent members and related members of a safety valve of the battery according to an embodiment of the present application;

FIG. 4 is a schematic sectional view of constituent members of the safety valve of the battery according to an embodiment of the present application;

FIG. 5 is a schematic sectional view illustrating a state of the safety valve of the battery according to an embodiment of the present application before operation;

FIG. 6 is a schematic sectional view illustrating a state of the safety valve of the battery according to an embodiment of the present application after operation;

FIG. 7 is a schematic sectional view illustrating a state of the safety valve of the battery according to an embodiment of the present application after operation;

FIG. 8 is a schematic sectional view illustrating a state of the safety valve of the battery according to an embodiment of the present application after operation;

FIG. 9 is a schematic perspective view of an exterior body of the battery according to an embodiment of the present application;

FIG. 10 is a schematic sectional view of the safety valve of the battery according to an embodiment of the present application;

FIG. 11 is a schematic sectional view illustrating a state of the safety valve of the battery according to an embodiment of the present application after operation;

FIG. 12 is a schematic sectional view illustrating a conventional structure of a safety valve; and

FIG. 13 is a schematic sectional view illustrating a conventional structure of a safety valve.

### DETAILED DESCRIPTION

The present application will be described below in further detail according to an embodiment. The following description and examples are not intended to limit the subject matter described herein. That is, the present application is not particularly limited to the preferred aspects and the like described herein, but can be appropriately modified. In consideration of the description of the main points or ease of understanding, the present application may be illustrated by being divided into embodiments including examples, and the like for convenience, but partial replacement and/or combination of configurations illustrated in different embodiments and the like are possible. In the description of such embodiments, redundant description of substantially the same matters may be omitted, and only different points may be described. In particular, the same functions and effects by the same configurations are not sequentially mentioned for each embodiment in some cases.

In the description of the present specification, reference to a direction, an orientation, or the like is merely for convenience of description, and is not intended to limit the scope of the present application unless otherwise explicitly described. For example, relative terms such as “outside (or outer side, outer part, or outer circumference)”, “inside (or inner side, inner part, or inner circumference)” and their derivatives should be understood to refer to directions as described or illustrated. In the same manner, “above” an element includes not only a case of being in contact with the upper surface of the element but also a case of not being in contact with the upper surface of the element. That is, “above” an element includes not only an upper position away from the element, that is, an upper position via another object on the element or an upper position spaced apart from the element, but also a position immediately above the element in contact with the element. In addition, “above” does not necessarily mean the upper side in a vertical direction. “Above” merely indicates a relative positional relationship of certain elements. That is, unless otherwise explicitly described, the present disclosure is not required to be limited only to a specific direction, orientation, form, or the like. Terms such as “provided”, “disposed”, “connected”, and “attached”, and derived terms thereof are also the same, and are not limited to a direct mode, but may be a mode in which another element such as an inclusion is interposed unless otherwise explicitly described.

The “battery” as used herein includes not only a so-called “secondary battery” but also a “primary battery” capable of only discharging. That is, the “battery” in the present specification may be a “secondary battery” that can be repeatedly charged and discharged, or a “primary battery” that is substantially only discharged. The “secondary battery” is not excessively limited by its name, and for example, a “power storage device” and the like can also be included in the subject.

Hereinafter, for convenience of description, a battery according to the present application will be described by taking a secondary battery as an example.

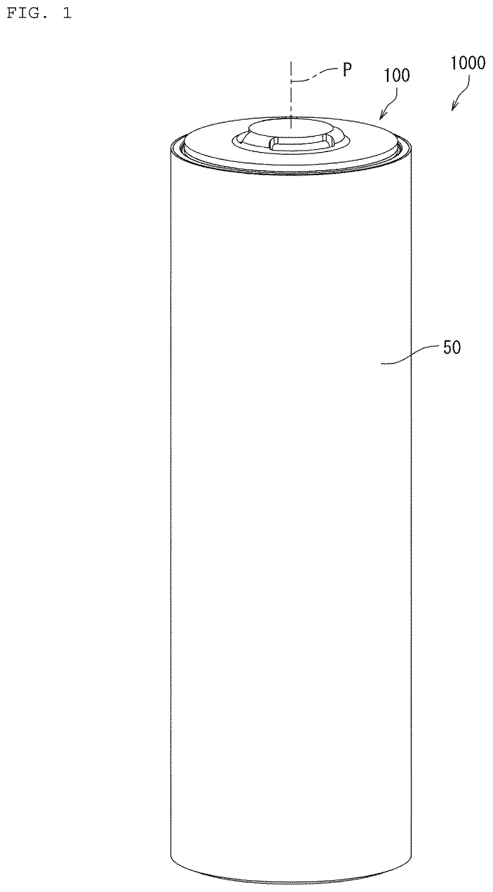

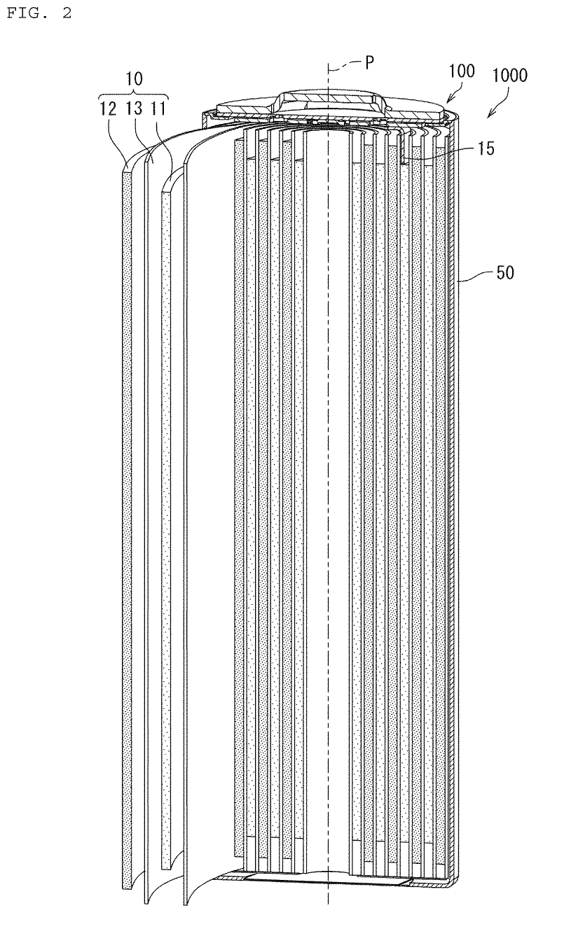

A secondary battery according to the present application includes a battery assembly including a positive electrode, a negative electrode, and a separator. In the secondary battery according to the present application, the battery assembly may include a wound structure (hereinafter, also referred to as a “wound electrode body” or a “wound structure”) in which the positive electrode, the negative electrode, and the separator are wound in a roll shape. FIG. 1 schematically illustrates an exemplary aspect of an external appearance of a secondary battery 1000, and FIG. 2 schematically illustrates an exemplary aspect of an internal structure of the secondary battery. As illustrated in the drawing, a battery assembly 10 is housed inside an exterior body 50. In the exemplary aspect illustrated in FIG. 2, the battery assembly 10 has a configuration in which a positive electrode 11, a negative electrode 12, and a separator 13 disposed between the positive electrode 11 and the negative electrode 12 are wound. In the secondary battery 1000, such a battery assembly 10 is sealed in the exterior body 50 together with an electrolyte (for example, a nonaqueous electrolyte).

The positive electrode includes at least a positive electrode material layer and a positive electrode current collector. In the positive electrode, the positive electrode material layer is provided on at least one surface of the positive electrode current collector. The positive electrode material layer contains a positive electrode active material as an electrode active material. For example, for each of a plurality of positive electrodes in the battery assembly, the positive electrode material layer may be provided on both surfaces of the positive electrode current collector, or may be provided only on one surface of the positive electrode current collector.

The negative electrode includes at least a negative electrode material layer and a negative electrode current collector. In the negative electrode, the negative electrode material layer is provided on at least one surface of the negative electrode current collector. The negative electrode material layer contains a negative electrode active material as an electrode active material. For example, for each of a plurality of negative electrodes in the battery assembly, the negative electrode material layer may be provided on both surfaces of the negative electrode current collector, or may be provided only on one surface of the negative electrode current collector.

The electrode active materials included in the positive electrode and the negative electrode, that is, the positive electrode active material and the negative electrode active material are substances directly involved in the transfer of electrons in the secondary battery, and are main substances of the positive and negative electrodes, which are responsible for charging and discharging, that is, a battery reaction. More specifically, ions are brought in the electrolyte due to the “positive electrode active material contained in the positive electrode material layer” and the “negative electrode active material contained in the negative electrode material layer”, and such ions move between the positive electrode and the negative electrode to transfer electrons, thereby performing charging and discharging. The positive electrode material layer and the negative electrode material layer may be layers particularly capable of occluding and releasing lithium ions. That is, the secondary battery according to the present application may be a nonaqueous electrolyte secondary battery in which lithium ions move between the positive electrode and the negative electrode through a nonaqueous electrolyte, whereby charging and discharging of the battery is performed. When lithium ions are involved in charging and discharging, the secondary battery according to the present application corresponds to a so-called “lithium ion battery”, and the secondary battery includes layers capable of occluding and releasing lithium ions as the positive electrode and the negative electrode.

In view of a lithium ion battery, the positive electrode active material may be a material that contributes to occlusion and release of lithium ions. That is, the positive electrode layer may contain any one of, or two or more of positive electrode materials capable of occluding and releasing lithium. In such a viewpoint, the positive electrode active material may be, for example, a lithium-containing compound. The type of the lithium-containing compound is not particularly limited, but examples thereof include a lithium-containing composite oxide and a lithium-containing phosphate compound. This is because a high energy density is likely to be obtained.

The lithium-containing composite oxide is a generic name of oxides containing lithium and one of, or two or more of other elements (elements other than lithium) as constituent elements, and may have, for example, one of crystal structures such as a layered rock-salt type crystal structure and a spinel type crystal structure. The lithium-containing phosphate compound is a generic name of phosphate compounds that contain lithium and one of, or two or more of the other elements as constituent elements, and may have, for example, a crystal structure such as an olivine crystal structure. The type of the other element is not particularly limited as long as the element is any one or two or more of optional elements. Among these, the other element is one of, or two or more of elements belonging to Groups 2 to 15 in a long-period periodic table. More specific examples of the other elements includes nickel (Ni), cobalt (Co), manganese (Mn) and iron (Fe). This is because a high voltage is likely to be obtained by these additive elements.

Examples of the lithium-containing composite oxide having a layered rock-salt type crystal structure may include compounds represented by the following respective Formulas (1) to (3).

LiₐMn_{(1-b-c)}Ni_{b}M11_{c}O_{(2-d)}Fₑ (1)
(M11 is at least one of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); a to e satisfy 0.8≤a≤1.2, 0<b<0.5, 0≤c≤0.5, (b+c)<1, −0.1≤d≤0.2, and 0≤e≤0.1. However, the composition of lithium varies depending on the charged and discharged states, and a is a value in a fully discharged state.)

LiₐNi_{(1-b)}M12_{b}O_{(2-c)}F_{d} (2)
(M12 is at least one of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W); a to d satisfy 0.8≤a≤1.2, 0.005≤b≤0.5, −0.1≤c≤0.2, and 0≤d≤0.1. However, the composition of lithium varies depending on the charged and discharged states, and a is a value in a fully discharged state.)

LiₐCo_{(1-b)}M13_{b}O_{(2-c)}F_{d} (3)
(M13 is at least one of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.8≤a≤1.2, 0≤b<0.5, −0.1≤ c≤0.2, and 0≤d≤0.1. However, the composition of lithium varies depending on the charged and discharged states, and a is a value in a fully discharged state.)

Specific examples of the lithium-containing composite oxide having a layered rock salt type crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂.

When the lithium-containing composite oxide having a layered rock-salt crystal structure contains nickel, cobalt, manganese, and aluminum as constituent elements, the atomic ratio of nickel is preferably 50 atomic % or more. This is because a high energy density is likely to be obtained.

Examples of the lithium-containing composite oxide having a spinel type crystal structure may include a compound represented by the following Formula (4).

LiₐMn_{(2-b)}M14_{b}O_{c}F_{d} (4)

(M14 is at least one of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); a to d satisfy 0.9≤a≤1.1, 0≤b≤0.6, 3.7≤c≤4.1, and 0≤d≤0.1. However, the composition of lithium varies depending on the charged and discharged states, and a is a value in a fully discharged state.)

Specific examples of the lithium-containing composite oxide having a spinel type crystal structure may include LiMn₂O₄.

Examples of the lithium-containing phosphate compound having an olivine type crystal structure include a compound represented by the following Formula (5).

LiₐM15PO₄ (5)

(M15 is at least one of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr); a satisfies 0.9≤a≤1.1. However, the composition of lithium varies depending on the charged and discharged states, and a is a value in a fully discharged state.)

Specific examples of the lithium-containing phosphate compound having an olivine type crystal structure may include LiFePO₄, LiMnPO₄, LiFe_{0.5}Mn_{0.5}PO₄, and LiFe_{0.3}Mn_{0.7}PO₄.

The lithium-containing composite oxide may be a compound represented by the following Formula (6).

(Li₂MnO₃)ₓ(LiMnO₂)₁₋ₓ (6)

(x satisfies 0≤x≤1. However, the composition of the lithium varies depending on the charged and discharged states, and x is a value of a fully discharged state.)

In addition to these, the positive electrode material may be any one of, or two or more of, for example, oxides, disulfides, chalcogenides, and conductive polymers. Examples of the oxide may include titanium oxide, vanadium oxide, and manganese dioxide. Examples of the disulfide include titanium disulfide and molybdenum sulfide. The chalcogenide is, for example, niobium selenide or the like. The conductive polymer may be, for example, sulfur, polyaniline, polythiophene, or the like. However, the positive electrode material is not particularly limited, and it may be a material other than the above materials.

The positive electrode material layer may contain a binder. A positive electrode conductive agent may also be contained in the positive electrode material layer to facilitate transmission of electrons promoting the battery reaction. The binder of the positive electrode may contain, for example, any one of, or two or more of synthetic rubbers and polymer compounds. The synthetic rubber is, for example, styrene-butadiene rubber, fluorine rubber, ethylene propylene diene, or the like. The polymer compound is, for example, polyvinylidene fluoride, polyimide, or the like. The positive electrode conductive agent may contain, for example, any one of, or two or more of carbon materials. The carbon material may be, for example, graphite, carbon black, acetylene black, ketjen black, or the like. However, the positive electrode conductive agent may be a metal material, a conductive polymer and the like as long as it is a material exhibiting conductivity.

In the same manner, the negative electrode active material of the negative electrode material layer may be a material that contributes to occlusion and release of lithium ions. That is, the negative electrode layer may contain any one of, or two or more of negative electrode materials capable of occluding and releasing lithium. In such a viewpoint, the negative electrode active material may be, for example, various carbon materials, metal-based materials, and/or other materials.

When a carbon material is used as the negative electrode active material, a change in the crystal structure at the time of occlusion of lithium and at the time of release of lithium is very small, and thus a high energy density is likely to be obtained stably. In addition, the carbon material also serves as the negative electrode conductive agent, which tends to improve conductivity of the negative electrode active material layer.

Specific examples of the carbon material include graphitizable carbon, non-graphitizable carbon, and/or graphite. More specifically, the carbon material may be, for example, pyrolytic carbons, cokes, glassy carbon fiber, organic polymer compound fired body, activated carbon, carbon blacks, or the like. The cokes may include pitch coke, needle coke, and petroleum coke. The organic polymer compound fired body is, for example, a material obtained by firing (carbonizing) a polymer compound such as phenol resin and furan resin at appropriate temperature. In addition, the carbon material may be low crystalline carbon subjected to a heat treatment at a temperature of about 1000° C. or less, or may be amorphous carbon. The shape of the carbon material may be at least one of a fibrous shape, a spherical shape, a granular shape, and a scaly shape without particular limitation.

This “metal-based material” used as the negative electrode active material is a generic term for materials containing any one of, or two or more of metal elements and metalloid elements as constituent elements. When a carbon material is used as the negative electrode active material, a high energy density is likely to be obtained. The metal-based material may be a single metal, an alloy, a compound, two or more of these, or may be a material at least a part of which has phases composed of one of, or two or more of these. However, the alloy may include a material containing one or more metal elements and one or more metalloid elements in addition to a material composed of two or more of metal elements. The alloy may also contain a non-metallic element. The construction of this metal-based material may be, for example, a solid solution, a eutectic (eutectic mixture), an intermetallic compound, and a material in which two or more of them coexist. Such metal element and metalloid element may be, for example, any one of, or two or more of metal elements and metalloid elements capable of forming an alloy with lithium. Specific examples of the metal element and the metalloid element may include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium, yttrium (Y), palladium (Pd), and/or platinum (Pt). In a preferred aspect, the metal elements are silicon and tin. This is because these metal elements have excellent ability to occlude and release lithium, and a higher energy density is likely to be obtained. A material containing silicon as a constituent element may be a simple substance of silicon, an alloy of silicon, or a compound of silicon, may be two or more selected from these materials, or may be a material at least a part of which has phases composed of one of, or two or more of these. A material containing tin as a constituent element may also be a simple substance of tin, an alloy of tin, or a compound of tin, may be two or more thereof, or may be a material at least a part of which has phases composed of one of, or two or more of these. The “simple substance” described in the present specification is a simple substance in a general sense to the utmost, and thus the simple substance may contain a small amount of impurities. That is, the purity of the single substance is not necessarily limited to 100%. The alloy of silicon may contain, for example, any one of, or two or more of tin, nickel, copper, iron, cobalt, manganese, zinc, indium, silver, titanium, germanium, bismuth, antimony, chromium, and the like as constituent elements other than silicon. The compound of silicon may contain, for example, any one of, or two or more of carbon, oxygen, and the like as constituent elements other than silicon. The compound of silicon may contain, for example, any one of, or two or more of a series of elements described in the alloy of silicon as constituent elements other than silicon. Specific examples of the alloy of silicon and the compound of silicon include SiB₄, SiB₆, MgSi, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), and/or LiSiO. In SiOᵥ, v may be 0.2<v<1.4. The alloy of tin may contain, for example, any one of, or two or more of silicon, nickel, copper, iron, cobalt, manganese, zinc, indium, silver, titanium, germanium, bismuth, antimony, chromium, and the like, as constituent elements other than tin. The compound of tin may contain, for example, any one of, or two or more of carbon, oxygen, and the like, as constituent elements other than tin. The compound of tin may contain any one of, or two or more of a series of elements described in the alloy of tin, for example, as constituent elements other than tin. Specific examples of the alloy of tin and the compound of tin may include Snow (0<w≤2), SnSiO₃, LiSno, and/or Mg₂Sn. In particular, the material containing tin as a constituent element may be, for example, a material (tin-containing material) containing a second constituent element and a third constituent element together with tin which is a first constituent element. The second constituent element may be, for example, any one of, or two or more of cobalt, iron, magnesium, titanium, vanadium, chromium, manganese, nickel, copper, zinc, gallium, zirconium, niobium, molybdenum, silver, indium, cesium (Ce), hafnium (Hf), tantalum, tungsten, bismuth, silicon, and the like. The third constituent element may be, for example, any one of, or two or more of boron, carbon, aluminum, phosphorus, or the like. This is because high battery capacity and excellent cycle characteristics are likely to be obtained by these elements. In particular, the tin-containing material may be a material (tin cobalt carbon-containing material) containing tin, cobalt, and carbon as constituent elements. This is because a high energy density is likely to be obtained by these materials. In the tin cobalt carbon-containing material, at least part of carbon which is a constituent element may be bonded to a metal element or metalloid element which is another constituent element. This is because the aggregation of tin, crystallization of tin, and the like are likely to be suppressed. Such a tin-cobalt-carbon-containing material is not limited to the material (SnCoC) that contains only tin, cobalt, and carbon as constituent elements. This tin-cobalt-carbon-containing material may further contain, for example, any one of, or two or more of silicon, iron, nickel, chromium, indium, niobium, germanium, titanium, molybdenum, aluminum, phosphorus, gallium, bismuth and the like as a constituent element in addition to tin, cobalt, and carbon. In addition to the tin-cobalt-carbon-containing material, a material (tin-cobalt-iron-carbon-containing material) containing tin, cobalt, iron, and carbon as constituent elements may also be used.

In addition to these, the negative electrode material may be any one of, or two or more of, for example, metal oxides and polymer compounds. Examples of the metal oxide may include iron oxide, ruthenium oxide, and molybdenum oxide. Examples of the polymer compound may include polyacetylene, polyaniline, and polypyrrole.

The negative electrode material layer may contain a binder. Further, a negative electrode conductive agent may be included in the negative electrode material layer to facilitate the transfer of electrons promoting the battery reaction. The binder that may be contained in the negative electrode material layer is not particularly limited, but examples thereof include at least one selected from the group consisting of styrene-butadiene rubber, polyacrylic acid, polyvinylidene fluoride, polyimide-based resin, and polyamideimide-based resin. The negative electrode conductive agent that may be contained in the negative electrode material layer is not particularly limited, and examples of the negative electrode conductive agent may include at least one selected from the group consisting of carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, polyphenylene derivatives, and the like. The negative electrode material layer may include therein a component derived from a thickener component (for example, carboxymethyl cellulose) used at the time of producing the battery.

The positive electrode current collector and the negative electrode current collector used for the positive electrode and the negative electrode are members configured to contribute to collecting and supplying electrons generated in the electrode active material due to the battery reaction. Such an electrode current collector may be a sheet-shaped metal member. The electrode current collector may be a single layer or a multilayer. Further, the electrode current collector may have a porous or perforated form. For example, the current collector may be a metal foil, a punching metal, a net, an expanded metal, or the like. The positive electrode current collector used for the positive electrode may include, for example, a metal foil containing at least one selected from the group consisting of aluminum, nickel, stainless steel, and the like. On the other hand, the negative electrode current collector used for the negative electrode may include, for example, a metal foil containing at least one selected from the group consisting of copper, aluminum, nickel, stainless steel, and the like.

The separator used for the positive electrode and the negative electrode is a member provided from the viewpoints of the prevention of short circuit due to contact between the positive and negative electrodes and the holding of the electrolyte and the like. In other words, the separator is a member that separates the positive electrode and the negative electrode, and allows ions (for example, lithium ions) to pass while preventing a short circuit of a current due to contact between both electrodes. For example, the separator may be a porous or microporous insulating member, which may have a film form due to its small thickness.

This separator may be, for example, any one of, or two or more of porous films of synthetic resins, ceramics and the like, and it may be a stacked film of two or more of porous films. The synthetic resin used for the separator is, for example, polytetrafluoroethylene, polypropylene, polyethylene, or the like. For example, the separator may include, a porous film (substrate layer) and a polymer compound layer provided on one side or both sides of the substrate layer. This improves the close contact of the separator to the positive electrode and may improve the close contact of the separator to the negative electrode, and thus the distortion of the wound electrode body is likely to be suppressed. The polymer compound layer may contain, for example, any one of, or two or more of polymer compounds such as polyvinylidene fluoride. This makes it easy to have excellent physical strength and to be electrochemically stable. The polymer compound layer may contain any one of, or two or more of insulation grains such as an inorganic grain. Examples of the type of inorganic grain include aluminum oxide and aluminum nitride. In the present application, the separator is not to be particularly limited by its name, and it may be solid electrolytes, gel electrolytes, and/or insulating inorganic grains that have a similar function.

In the secondary battery of the present application, the battery assembly including the positive electrode, the negative electrode, and the separator may be enclosed in an exterior body together with an electrolyte. The electrolyte may be a nonaqueous electrolytic solution.

Typically, the electrolytic solution contains a solvent and an electrolyte salt. The electrolytic solution may further contain any one of, or two or more of other materials such as additives. In a preferred aspect, the separator may be impregnated with an electrolytic solution, and the positive electrode and/or the negative electrode may also be impregnated with an electrolytic solution.

The solvent may contain any one of, or two or more of nonaqueous solvents such as organic solvents. The electrolyte solution containing a nonaqueous solvent may be a so-called nonaqueous electrolyte solution. Examples of the nonaqueous solvent include a cyclic carbonate ester, a chain carbonate ester, a lactone, a chain carboxylate ester, and/or a nitrile (for example, mononitrile). This makes it easy to obtain more excellent battery capacity, cycle characteristics, and/or storage characteristics. Examples of the cyclic carbonate ester may include ethylene carbonate, propylene carbonate, and/or butylene carbonate. Examples of the chain carbonate ester may include dimethyl carbonate, diethyl carbonate, ethyl methyl carbonate, and/or methyl propyl carbonate. The lactone may be, for example, γ-butyrolactone and/or γ-valerolactone, or the like. Examples of the chain carboxylate ester may include methyl acetate, ethyl acetate, methyl propionate, ethyl propionate, methyl butyrate, methyl isobutyrate, methyl trimethylacetate, and/or ethyl trimethylacetate. Examples of the nitrile may include acetonitrile, methoxyacetonitrile, and/or 3-methoxypropionitrile. Examples of the nonaqueous solvent may also include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N, N-dimethylformamide, N-methylpyrrolidinone, N-methyloxazolidinone, N,N′-dimethylimidazolidinone, nitromethane, nitroethane, sulfolane, trimethyl phosphate, and/or dimethyl sulfoxide. Among these, the nonaqueous solvent preferably contains any one of, or two or more of ethylene carbonate, propylene carbonate, dimethyl carbonate, diethyl carbonate, ethyl methyl carbonate and the like. This is because higher battery capacity, more excellent cycle characteristics, and/or more excellent storage characteristics are likely to be provided. Further, examples of the nonaqueous solvent may include an unsaturated cyclic carbonate ester, a halogenated carbonate ester, a sulfonate ester, an acid anhydride, a dicyano compound (dinitrile compound), a diisocyanate compound, a phosphate ester, and/or a chain compound having a carbon-carbon triple bond. This makes it easy to improve the chemical stability of the electrolytic solution. The “unsaturated cyclic carbonate ester” described herein is a cyclic carbonate ester having one or two or more unsaturated bonds (carbon-carbon double bonds or carbon-carbon triple bonds). Examples of this unsaturated cyclic carbonate ester may include vinylene carbonate, vinyl ethylene carbonate, and/or methylene ethylene carbonate. The “halogenated carbonate ester” is a cyclic carbonate ester having one or two or more halogen elements as constituent elements or a chain carbonate ester having one or two or more halogen elements as constituent elements. When the halogenated carbonate ester contains two or more halogens as a constituent element, the type of the two or more halogens may be one type or two or more types. As the cyclic halogenated carbonate ester, for example, 4-fluoro-1,3-dioxolan-2-one, and/or 4,5-difluoro-1,3-dioxolan-2-one may be exemplified. The chain halogenated carbonate ester may be, for example, fluoromethyl methyl carbonate, bis(fluoromethyl) carbonate, and/or difluoromethyl methyl carbonate. The sulfonate ester may be, for example, a monosulfonate ester and/or a disulfonate ester. The monosulfonate ester may be a cyclic monosulfonate ester or a chain monosulfonate ester. The cyclic monosulfonate ester may be, for example, sultones such as 1,3-propane sultone and/or 1,3-propene sultone. Examples of the chain monosulfonate ester include a compound in which a cyclic monosulfonate ester is cut in the middle. The disulfonate ester may be a cyclic disulfonate ester or a chain disulfonate ester. The acid anhydride may be, for example, carboxylic acid anhydride, disulfonic acid anhydride, and/or carboxylic acid sulfonic acid anhydride. The carboxylic acid anhydride may be, for example, succinic anhydride, glutaric anhydride, and/or maleic anhydride. The disulfonic acid anhydride may be, for example, ethanedisulfonic anhydride and/or propanedisulfonic anhydride. The carboxylic acid sulfonic acid anhydride may be, for example, sulfobenzoic anhydride, sulfopropionic anhydride, and/or sulfobutyric anhydride. A dinitrile compound is, for example, a compound represented by NC-R1-CN (R1 represents either of an alkylene group or an arylene group). The dinitrile compound may be, for example, succinonitrile (NC—C₂H₄—CN), glutaronitrile (NC—C₃H₆—CN), adiponitrile (NC—C₄H₈—CN), and/or phthalonitrile (NC—C₆H₄—CN). A diisocyanate compound is, for example, a compound represented by OCN—R2-NCO (R2 represents either of an alkylene group or an arylene group). The diisocyanate compound may be, for example, hexamethylene diisocyanate (OCN—C₆H₁₂—NCO). The phosphate ester may be, for example, trimethyl phosphate and triethyl phosphate. The chain compound having a carbon-carbon triple bond is a chain compound having one or two or more carbon-carbon triple bonds (—C≡C—). This chain compound having a carbon-carbon triple bond may be, for example, propargyl methyl carbonate (CH≡C—CH₂—O—C(═O)—O—CH₃) and propargyl methanesulfonate (CH≡C—CH₂—O—S(═O)₂—CH₃).

The electrolyte salt contained in the electrolytic solution may include any one of, or two or more of salts such as a lithium salt, for example. The electrolyte salt may contain a salt other than a lithium salt, for example. Such a salt other than lithium may be, for example, salts of light metals other than lithium. Examples of the lithium salts include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and/or lithium bromide (LiBr). This is because more excellent battery capacity, cycle characteristics and/or storage characteristics can be obtained. In particular, the lithium salt may be any one of, or two or more of lithium hexafluorophosphate, lithium tetrafluoroborate, lithium perchlorate, and lithium hexafluoroarsenate.

The exterior body used for the secondary battery corresponds to, as a battery exterior body, a member enclosing the battery assembly in which a positive electrode, a negative electrode, and a separator are stacked. Such an exterior body can also be referred to as, for example, a “battery can”. The exterior body may have, for example, a hollow structure in which one end portion is closed and an opening is provided at the other end portion. The opening may be a through hole formed in one end portion of the exterior body. The structure of the exterior body including such an opening can also be understood as a structure including an open end portion whose one end is released. A safety valve may be provided in the opening of the exterior body. Although it is merely an example, a safety valve may be provided in the opening of the exterior body together with a battery lid, a thermosensitive resistive element, and the like.

When the secondary battery is overcharged, or when the battery is abnormally heated to a high temperature by heat energy applied from the outside due to exposure to a high temperature condition or the like, an undesired chemical reaction proceeds inside the exterior body, and gas such as carbon dioxide may be generated. At this time, when the pressure (that is, the internal pressure of the exterior body) inside the exterior body is increased by the generated gas, the exterior body may rupture as a result. In the conventional safety valve, a configuration is considered in which a current path of the battery is cut off and the gas is released by cutting off and cleaving a part of the constituent member of the safety valve when the internal pressure of the exterior body has increased. In such a safety valve, degassing is performed by cutting off the current path using a force acting from the inside of the exterior body toward the outside due to the increased internal pressure and then cleaving a part of the constituent member.

The inventors of the present application have found that the function of the safety valve preferentially required may be different depending on the state of the battery, and have studied a safety valve that can function appropriately regardless of the state of the battery. For example, the inventors of the present application have found that the function preferentially required for the safety valve may be different between the overcharged state and the abnormally high temperature state in which the battery has a high temperature.

In the overcharged state, a reaction for generating undesired gas can be stopped by cutting off the current path, and thus a cutoff mechanism for the current path is required to function. On the other hand, in the abnormally high temperature state, since gas is generated inside the exterior body due to high temperature, the internal pressure of the exterior body may increase after the current path is cut off. Thus, it is required not to cut off the current but to release a large amount of gas to the outside at an early stage. In a battery using the conventional safety valve, the internal pressure required from the cutoff of the current path to the cleavage is relatively high, and the amount of gas that can leak from the cleavage portion is relatively small, and thus the degassing becomes insufficient in an abnormally high temperature state, and the battery may rupture.

Against the problem described above, for example, the inventors of the present application have attempted to solve the problem by providing a battery including not only a cutoff mechanism of a current path for coping with an overcharged state but also a degassing mechanism for coping with an abnormally high temperature state. As a result, the inventors of the present application have reached a more reliable battery that can suppress or avoid rupture of the battery in both an overcharged state and an abnormally high temperature state. Hereinafter, features of the battery of the present application will be described in further detail according to an embodiment.

The battery of the present application has a feature related to a safety mechanism provided in the battery. In particular, the battery of the present application is characterized with respect to an exterior body of the battery and a safety valve combined with the exterior body (in particular, its opening). Hereinafter, for convenience of description, the battery according to an embodiment of the present application will be described by taking a secondary battery as an example.

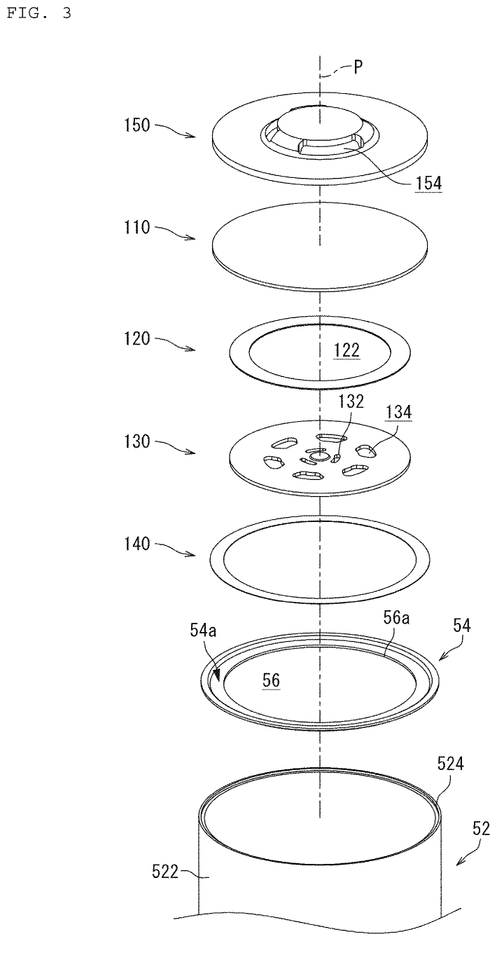

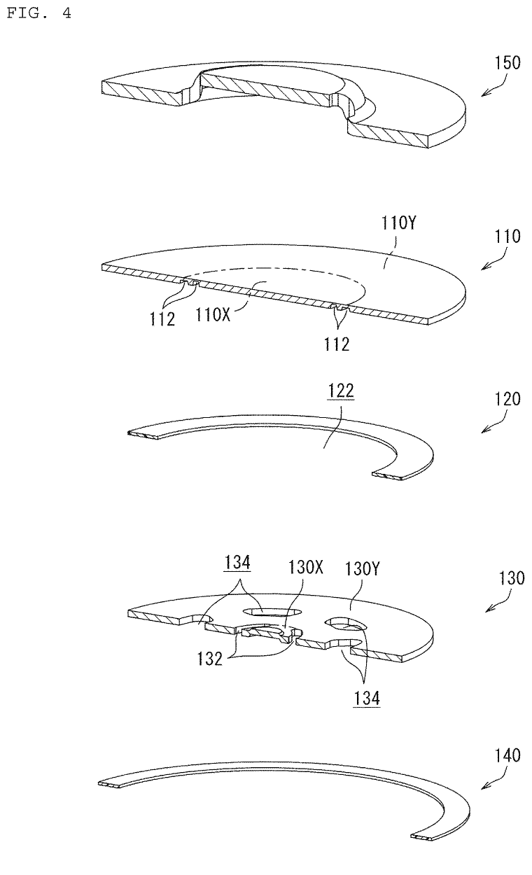

FIGS. 1 and 2 schematically illustrate an appearance of the battery of the present application and a sectional view thereof. As illustrated, the battery 1000 of the present application may be a cylindrical battery (for example, a cylindrical nonaqueous secondary battery). In other words, the battery of the present application may include a cylindrical case, that is, the cylindrical exterior body 50. A safety valve 100 may be provided at a cylindrical end portion of the battery 1000 (in particular, on opening 56 side of the exterior body). FIG. 3 illustrates the safety valve 100 in a developed state together with its related members (or peripheral members), and FIG. 4 illustrates each constituent member of the safety valve 100 as a half perspective view. FIG. 5 is an enlarged sectional view schematically illustrating the safety valve 100 included in the battery 1000 in a normal state. The “normal state” refers to a state in which the internal pressure of the battery, that is, the internal pressure of the exterior body 50 is in a normal range, and refers to a state in which the safety mechanism is not operated.

In the battery 1000 of the present application, the exterior body 50 includes a cylindrical portion 52. The exterior body 50 further includes a support portion 54 provided at one end portion of the cylindrical portion 52 so as to protrude inward from a body portion 522 of the cylindrical portion 52, and an opening 56 surrounded by the support portion 54. That is, the support portion 54 may protrude from the cylindrical portion 52 toward the inner peripheral side of the cylindrical portion 52. Such a structure can also be understood as a structure in which the support portion 54 extends so as to protrude from the edge of the cylindrical portion 52 toward a battery axis P. The opening 56 corresponds to an opening region surrounded by the support portion 54. The safety valve 100 provided in the battery of the present application is disposed on the support portion 54 in such a manner as to close the opening 56 of the exterior body. In other words, the support portion 54 supports the safety valve 100 disposed in such a manner as to close the opening 56. The safety valve 100 is positioned on the outer side of the exterior body 50 in such a manner as to cover the opening 56. That is, the safety valve 100 is positioned on the outer side with respect to the support portion 54 in the battery axial direction.

In the battery of the present application, a thermoplastic resin layer 140 is disposed between the safety valve 100 and the support portion 54. The safety valve 100 and the support portion 54 are fixed to each other with the thermoplastic resin layer 140 interposed therebetween. The safety valve 100 may be adhered and fixed to the exterior body 50 by the thermoplastic resin layer 140 disposed on the support portion 54. That is, the thermoplastic resin layer 140 is disposed between the safety valve 100 and the support portion 54, and can contribute to fixing of the safety valve 100 on the support portion 54.

The thermoplastic resin layer 140 disposed between the support portion 54 of the exterior body and the safety valve 100 is softened in a high temperature state. When the thermoplastic resin layer 140 is softened, a force for fixing (or adhering) the support portion 54 and the safety valve 100 may be reduced. When the battery is in an abnormally high temperature state and the internal pressure of the exterior body 50 is increased by the gas generated inside the exterior body 50, the safety valve 100 receives a force directed from the inside to the outside of the exterior body 50 due to the pressure. By receiving the force, fixing (adhesion) between the support portion 54 and the safety valve 100 via the thermoplastic resin layer 140 softened by high temperature is released, and the gas inside the exterior body 50 is released to the outside from between the support portion 54 and the safety valve 100. As a result, a battery that can suitably release the internal pressure increased due to the abnormally high temperature state and can suitably release the internal pressure of the battery not only in the overcharged state but also in the abnormally high temperature state can be provided.

In the battery of the present application, the safety valve 100 is at least partly detached from the exterior body 50, which makes it possible to release gas from the opening 56. Thus, in the battery of the present application, gas can be released in the opening region having a larger area as compared with the case where gas is released from a cleaved portion of the safety valve 100. Therefore, the gas in the exterior body 50 can be released more efficiently, and the internal pressure of the exterior body 50 can be released more quickly, which can suitably avoid the rupture of the battery.

Hereinafter, such a battery of the present application will be described in further detail including with reference to the drawings according to an embodiment. The configuration of the safety valve 100 of the battery includes at least a first metal member 110, a second metal member 130, and an insulating member 120 positioned therebetween. As one specific exemplary aspect, the following description will be given by exemplifying an aspect in which the first metal member 110 can correspond to a safety cover and the second metal member 130 can correspond to a stripper disk.

As illustrated in FIGS. 3 and 4, the safety valve 100 has a configuration in which a safety cover 110 provided as a first metal member, the insulating member 120, and a stripper disk 130 provided as a second metal member are combined with each other in this order. When viewed along an axial direction of the cylindrical shape of the battery, the safety cover 110, which is the first metal member, is relatively positioned on the outer side of the battery (that is, for example, the side farther from the battery assembly such as the wound structure), and the stripper disk 130, which is the second metal member, is relatively positioned on the inner side of the battery (that is, for example, the side closer to the battery assembly such as the wound structure). The insulating member 120 is interposed between the safety cover 110 and the stripper disk 130. The “axial direction of the cylindrical shape of the battery” in the present specification corresponds to the central axis of the cylindrical exterior body 50, and is also referred to as “battery axis” in the present specification. That is, the “battery axis” can mean an axis passing through the center of the exterior body 50 in a plan view in which the battery is captured from the end portion side of the exterior body 50 on which the safety valve 100 is disposed. For example, the “battery axis” may correspond to an axis extending in a direction perpendicular to an end surface of the exterior body (in particular, the end surface on a virtual plane) in such a manner as to pass through the center of the cylindrical portion 52 of the exterior body 50. For example, the “battery axis” can also be understood as an axis that passes through the center of the exterior body 50 and extends in a direction orthogonal to the extending direction of the safety valve 100.

The safety valve 100 at least includes, as a safety mechanism, a mechanism that contributes to a battery terminal (that is, an external terminal of the positive electrode or the negative electrode) and can be displaced according to an excessive internal pressure of the battery. More specifically, the safety valve 100 includes at least the safety cover 110 and the stripper disk 130 that can be displaced in response to excessive battery internal pressure, and the insulating member 120 disposed therebetween as constituent elements. Such a safety valve 100 is provided at one end portion of the exterior body 50, and is particularly provided at an end portion including the opening 56. The safety valve 100 may further include a top cover 150. The top cover 150 may be provided on the outer side of the battery with respect to the safety cover 110 provided as the first metal member. Hereinafter, each member constituting the safety valve 100 will be described in more detail.

The safety cover 110 provided as the first metal member mainly corresponds to a displaceable member that closes the opening 56 of the exterior body and is deformable and/or cleavable according to the internal pressure of the exterior body 50. As described above, the internal pressure of the exterior body 50 may be undesirably increased by the gas such as carbon dioxide generated when the battery is in an abnormal state. The safety cover 110 may be deformable and/or cleavable in accordance with the increase in such an internal pressure.

The safety cover 110 is a conductive member, for example, a metal member. For example, the safety cover 110 may include any one or two or more of metal materials such as aluminum (aluminum alloys such as A1050, A3203, and A5052), titanium, platinum, and gold.

The planar shape of the safety cover 110, that is, the outer contour shape in plan view (also referred to as “outer contour shape in plan view”) viewed along the battery axis P direction is not particularly limited, and it may be, for example, a circular shape, a polygonal shape, and other shapes. In the present specification, the “circular shape” is, for example, a perfect circle (true circle), an ellipse, a substantial circle, or the like. The substantial circle is, for example, a generic name of a partly or fully distorted shape of a true circle. The “polygonal shape” is, for example, a triangle, a quadrangle, a pentagon, a hexagon, or the like. The “other shapes” are, for example, shapes other than a circle whose outline is formed only by a curve, shapes in which two or more of polygons are combined, and shapes in which one or more of circles and one or more of polygons are combined. Such a definition is the same hereinafter. In the illustrated exemplary aspect, the outer contour shape in plan view of the safety cover 110 is a circular shape.

The safety cover 110 may have, for example, a flat plate shape as a whole. That is, the safety cover 110 may have a form extending on the same plane. Although it is merely an example, the thickness of the safety cover 110 may be substantially constant except for a groove portion 112 and the like provided in the safety cover 110.

The insulating member 120 is interposed between the safety cover 110 and the stripper disk 130, and corresponds to a member that enables at least the safety cover 110 and the stripper disk 130 to be connected to each other. The insulating member 120 may have an annular shape as a whole. That is, the plan view shape of the insulating member 120 may be a loop shape, a ring shape, or the like. Because of such an annular shape, a loop shape, or a ring shape, the insulating member 120 may form a hollow portion or an opening region 122 in its central region. The outer contour shape in plan view of such an insulating member 120 is not particularly limited, but may be the same as the outer contour shape in plan view of the safety cover 110, or may be the same as the outer contour shape in plan view of the stripper disk 130. For example, the contour shape in plan view can be a circular shape. The annular shape, the loop shape, or the ring shape of the insulating member 120 may be a continuous form as a whole of the member, or may be a form in which the insulating member is locally divided and/or cut away.

The insulating member 120 may have, for example, a flat plate shape as a whole. That is, the insulating member 120 may have a form extending on the same plane. Although it is merely an example, the insulating member 120 may have a substantially constant thickness between the safety cover 110 and the stripper disk 130.

The insulating member 120 is a member having an insulation property. Thus, electrical conduction via the insulating member 120 is preferably prevented. The term “insulation” described in the present specification may have an electrical resistivity of a typical insulator because of the insulation property of the general insulator. The insulating member 120 may have a resistivity of at least 1.0×10⁵ Ω·m or more, preferably 1.0×10⁶ Ω·m or more, and more preferably 1.0×107 Ω·m or more (room temperature: 20° C.) although it is merely an example.

In a preferred aspect, the insulating member 120 interposed between the safety cover 110 and the stripper disk 130 are adhered to the safety cover and the stripper disk. In other words, the insulating member 120 may be interposed between the safety cover 110 and the stripper disk 130 as an adhesive layer. Preferably, the insulating member 120 may be interposed between the safety cover 110 and the stripper disk 130 so that the opening region 122 of the insulating member is positioned in the region including the battery axis P. The opening region 122 is positioned at a position corresponding to a central region 110X of the safety cover. The plan view shape of the opening region 122 is not particularly limited, and the shape may be, for example, the same as the outer contour shape in plan view of the safety cover 110. In the illustrated exemplary aspect, the plan view shape of the opening region 122 is a circular shape.

The insulating member 120 preferably includes an insulating resin material. This is because the resin material can suitably contribute to the close contact between the safety cover 110 and the stripper disk 130 while ensuring the insulation property, and thus contributes to the realization of a thinner safety valve. When the insulating member 120 includes a resin material, for example, the insulating member 120 may include a thermosetting resin, a thermoplastic resin, and/or a UV curable resin. When the viewpoint of adhesiveness is particularly emphasized, the insulating member 120 may be a member containing a resin adhesive having an insulation property. Examples of such a resin adhesive include an acrylic resin adhesive material such as an acrylic acid ester copolymer, a silicone-based resin adhesive material such as silicone rubber, a urethane-based resin adhesive material such as a urethane resin, an α-olefin-based resin adhesive, an ether-based resin adhesive, an ethylene-vinyl acetate resin-based resin adhesive material, an epoxy resin-based resin adhesive material, a vinyl chloride resin-based resin adhesive material, a chloroprene rubber-based resin adhesive material, a cyanoacrylate-based resin adhesive material, an aqueous polymer-isocyanate-based resin adhesive material, a styrene-butadiene rubber-based resin adhesive material, a nitrile rubber-based resin adhesive material, a nitrocellulose-based resin adhesive material, a reactive hot-melt-based resin adhesive material, a phenol resin-based resin adhesive material, a silicone-based resin adhesive material, a polyamide resin-based resin adhesive material, a polyimide-based resin adhesive material, a polyurethane resin-based resin adhesive material, a polyolefin-based resin adhesive material, a polyvinyl acetate-based resin solvent adhesive material, a polystyrene resin solvent adhesive material, a polyvinyl alcohol-based resin adhesive material, a polyvinyl pyrrolidone resin-based resin adhesive material, a polyvinyl butyral resin-based resin adhesive material, a polybenzimidazole-based resin adhesive material, a polymethacrylate resin-based resin adhesive material, a melamine resin-based resin adhesive material, an urea resin-based resin adhesive material, and/or a resorcinol-based resin adhesive material.

The stripper disk 130 provided as the second metal member is disposed relatively on the inner side of the battery with respect to the safety cover 110 via the insulating member 120. The stripper disk 130 corresponds to a member that contributes to the cutoff of electrical connection between the battery assembly disposed inside the exterior body 50 and the safety cover 110 and/or the top cover 150.

The stripper disk 130 is provided with a groove portion 132 for cutting off a current path when the battery is in an abnormal state. For example, the groove portion 132 may be provided in such a manner as to surround the battery axis P. In other words, the groove portion 132 may be an annular groove formed in such a manner as to surround the center of the opening 56. The groove portion 132 may have a continuous annular shape surrounding the battery axis P, or may have an intermittent annular shape. Alternatively, instead of the groove portion 132, (or together with the groove portion 132) linear through holes may be intermittently provided around the battery axis P. The groove portion 132 may be a groove having an opening toward the outside of the battery axis P. That is, the groove portion 132 may have a groove opening on the surface facing the outside of the battery relatively in the battery axis P direction among the surfaces of the second metal member.

The stripper disk 130 is a conductive member, for example, a metal member. For example, the safety cover 110 may include any one or two or more of metal materials such as aluminum (aluminum alloys such as A1050, A3203, and A5052), titanium, platinum, and gold. The material of the stripper disk 130 may be the same as the material of the safety cover 110 or different from the material of the safety cover 110.

The outer contour shape in plan view of the stripper disk 130 is not particularly limited, and may be, for example, a circle shape, a polygonal shape, or another shape. The outer contour shape in plan view of the stripper disk 130 may be the same as the outer contour shape of the safety cover 110 in plan view. In the illustrated exemplary aspect, the outer contour shape in plan view of the safety cover 110 is a circular shape.

The stripper disk 130 may have, for example, a flat plate shape as a whole. That is, the stripper disk 130 may have a form of extending on the same plane. For example, the stripper disk 130 may have a substantially constant thickness except for the groove portion 132 and the like provided in the stripper disk. The central region 130X of the stripper disk 130 may be relatively thick as compared with other regions in order to contribute to connection with the safety cover 110. In other words, although the stripper disk 130 has a plate shape as a whole, the thickness of the central portion of the region including the battery axis P may be relatively large.

In the safety valve 100, while the safety cover 110 and the stripper disk 130 are integrated by the insulating member 120 interposed therebetween, they may be electrically connected to each other in a central region thereof. For example, the safety cover 110 may be directly connected to the central region 130X of the stripper disk 130 in such a manner as to straddle the insulating member 120. More specifically, as illustrated in FIG. 5, the central region 110X of the safety cover 110 and the central region 130X of the stripper disk 130 may be directly connected to each other through the opening region 122 of the insulating member.

As described above, the safety valve 100 may further include the top cover 150. That is, the top cover 150 may be further provided on the relatively outer side with respect to the safety cover 110 provided as the first metal member. That is, the top cover 150 may be disposed on the outer side of the battery relative to the safety cover in the battery axis P direction. The top cover 150 is preferably electrically connected to the safety cover 110. The top cover 150 may be provided with a plurality of openings 154. The plurality of openings 154 mainly correspond to discharge ports that contribute to the passage or release of the gas inside the exterior body when the gas leaks from the cleavage portion of the safety cover 110.

The top cover 150 is a conductive member, and may be, for example, a metal member. For example, the top cover 150 may include any one or two or more of metal materials such as aluminum (aluminum alloys such as A1050, A3203, and A5052), titanium, platinum, and gold.

The top cover 150 can function as a terminal of the battery. For example, the top cover 150 may function as a positive electrode terminal of the battery, and the exterior body 50 may function as a negative electrode terminal. Thus, the top cover 150 and the exterior body 50 may be insulated from each other.

A conductive member 15 extending from the battery assembly is connected to the safety valve 100. More specifically, the conductive member 15 is connected to the stripper disk 130 of the safety valve. In particular, the conductive member 15 may be connected to a non-central region 130Y, which is a region on the outer peripheral side of the groove portion 132 of the stripper disk. The “non-central region” is a region other than the central region 130X on the inner peripheral side with respect to the groove portion 132, and can also be referred to as an “outer peripheral region”. The conductive member 15 is electrically connected to the battery assembly (in particular, any one of the positive electrode and the negative electrode), and contributes to electrical connection between the battery assembly and the safety valve 100 (in particular, the stripper disk 130). In the safety valve 100, the stripper disk 130 is electrically connected to the safety cover 110 with the central region 130X thereof interposed therebetween. The safety cover 110 is electrically connected to the top cover 150 forming an external terminal of the battery. Thus, the battery assembly such as a wound structure is electrically connected to the external terminal of the battery with the conductive member 15 interposed therebetween.

The conductive member 15 may be a conductive member containing metal, and preferably may be a metal member having an elongated shape. For example, the conductive member 15 may include an electrode current collector of the battery assembly, or may be a current collecting lead provided in the battery assembly (in particular, in its electrode). When the conductive member 15 includes an electrode current collector, the conductive member 15 may include a portion of the electrode current collector where the electrode material is not provided. When the conductive member 15 is a current collecting lead, the conductive member 15 may include a metal member having a thin form and/or a long form, and may be connected to an electrode. In the present application, the conductive member 15 that electrically connects the battery assembly and the electrode terminal to each other can also be referred to as “tab”. The conductive member 15 used for the secondary battery preferably has flexibility, and it may be provided in a warped form and/or a bent form.

In the safety valve 100 according to the battery of the present application, the safety cover 110 as the first metal member, the insulating member 120, and the stripper disk 130 as the second metal member described above are combined so as to be stacked on each other. More specifically, as illustrated in FIG. 5, the safety cover 110 provided as the first metal member and the insulating member 120 are disposed so as to be stacked on each other, the insulating member 120 and the stripper disk 130 provided as the second metal member are disposed so as to be stacked on each other, and the top cover 150 is disposed so as to be stacked on the safety cover 110.

Such an assembly of the safety valve is disposed on the outer side of the exterior body 50 in such a manner as to close the opening 56 provided at one end portion of the exterior body 50. The exterior body 50 according to the battery of the present application includes the cylindrical portion 52 and the support portion 54 protruding inward from the body portion 522 (for example, an edge 524 of the body portion) of the cylindrical portion 52 at one end of the cylindrical portion 52. The opening 56 surrounded by the support portion 54 is provided on the end surface of the exterior body including the support portion 54. That is, the exterior body 50 includes the opening 56 at one end, and the support portion 54 is provided in such a manner as to protrude from the cylindrical portion 52 of the exterior body toward the battery axis P around the opening 56. The support portion 54 is a portion protruding toward the inner peripheral side of the cylindrical portion 52 at the edge 524 of the cylindrical portion 52 of the exterior body, is also understood as a portion forming an end surface of the exterior body 50, and can also be referred to as an “overhanging portion”, an “end surface overhanging portion”, or the like.

The support portion 54 may be a member separate from the cylindrical portion 52 (see FIG. 3). That is, the support portion 54 may have an outer contour shape in plan view corresponding to the plan view shape of the edge 524 of the cylindrical portion 52, and may be combined with the edge 524 of the cylindrical portion 52 using a welding method or the like. A through hole is formed in a region surrounded by the support portion, and the through hole corresponds to the opening 56 of the exterior body. The battery including the exterior body having such a structure can be, for example, a battery having a structure without a beading portion.

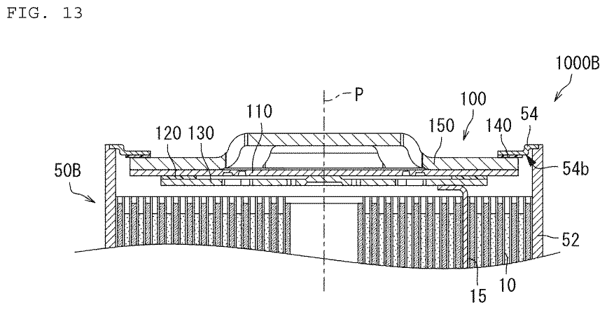

In the conventional safety valve structure, a safety valve is disposed on the exterior body 50 including a beading portion 58 formed over the outer periphery of the body portion 522 of the cylindrical portion 52 of the exterior body. The “beading portion” refers to a portion narrowed toward the battery axis P side in the body portion 522 of the cylindrical portion 52. In other words, the “beading portion” is a portion that is narrowed so as to protrude toward the inside of the exterior body 50, and can also be referred to as a “narrowed portion” or a “constricted portion”. Conventionally, in a battery including an exterior body having the beading portion 58, a support member such as a gasket is disposed in the beading portion 58, and a safety valve is held inside the exterior body with the gasket portion interposed therebetween (FIG. 12). That is, the conventional safety valve is disposed inside the exterior body including the beading portion 58.

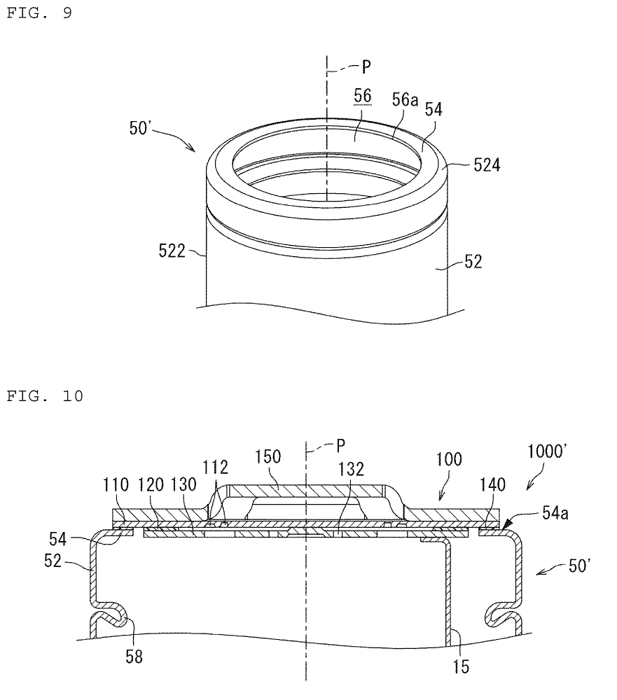

On the other hand, according to the present application, since the safety valve can be disposed on the outer side of the exterior body 50, the safety valve can be disposed without depending on the beading portion. Thus, the safety valve can be disposed not only on the exterior body including the beading portion but also on the exterior body not including the beading portion. In the exterior body 50 not including the beading portion, the inner diameter dimension of the exterior body 50 may be substantially constant along the battery axis P. Thus, the exterior body 50 can secure a wider internal space of the exterior body in which the battery assembly can be disposed as compared with an exterior body 50′ (see FIGS. 9 and 10) having the beading portion 58. That is, using an exterior body not including the beading portion makes it possible to provide a battery having a higher energy density. According to the present application, since the safety valve can be suitably disposed on the exterior body not including the beading portion, a battery having a high energy density and excellent safety can be obtained.

On the other hand, the exterior body may include a beading portion. FIG. 9 is an exploded perspective view of the exterior body 50′ according to an embodiment of the present application. FIG. 10 is a perspective partial sectional view of a battery including the exterior body 50′. The support portion 54 may be a portion continuous from the cylindrical portion 52. That is, the support portion 54 and the cylindrical portion 52 may be integrated. More specifically, the support portion 54 may correspond to a portion where the member forming the cylindrical portion 52 is bent toward the battery axis P at the edge 524 of the cylindrical portion 52 and protrudes toward the inner peripheral side of the cylindrical portion 52. In an embodiment, the support portion 54 may correspond to an overhanging surface formed on the edge 524 of the exterior body by crimping one open end of the cylindrical portion 52. According to the present application, the safety valve can be suitably disposed regardless of the presence or absence of a beading portion.

Both the cylindrical portion 52 and the support portion 54 of the exterior body may be conductive members. That is, the cylindrical portion 52 and the support portion 54 may be electrically connected to each other. For example, the cylindrical portion 52 and the support portion 54 may include one of, or two or more of metal materials such as iron, aluminum, stainless steel, and alloys thereof. The cylindrical portion 52 and the support portion 54 may be made of the same material or different materials. For example, any one of, or two or more of metal materials such as nickel may be plated on the surface of the cylindrical portion 52 and/or the support portion 54.

In the battery of the present application, the safety valve 100 is disposed on the support portion 54 of the exterior body. That is, the safety valve 100 is positioned on the outer side of the battery with respect to the support portion 54. Such a structure can also be understood that the safety valve 100 is disposed on the outer side with respect to the support portion 54 in the battery axis P direction. More specifically, the safety valve 100 may be adhered to an outer main surface 54a positioned relatively on the outer side of the exterior body 50 out of the two main surfaces extending in the radial direction. The thermoplastic resin layer 140 is interposed between the safety valve 100 and the support portion 54. The thermoplastic resin layer 140 may be disposed on the outer main surface 54a of the support portion to fix the safety valve 100 on the support portion 54. The plan view shape of the thermoplastic resin layer 140 may be an annular shape along an opening end 56a of the opening. Thus, the thermoplastic resin layer 140 may extend around the opening end 56a of the opening in such a manner as to surround the opening 56.

The thermoplastic resin layer 140 interposed between the safety valve 100 and the support portion 54 may be adhered to each other. In other words, the thermoplastic resin layer 140 may be interposed between the safety valve 100 and the support portion 54 as an adhesive layer. Thus, the safety valve 100 and the support portion 54 may be adhered to each other with the thermoplastic resin layer 140 interposed therebetween. Such a thermoplastic resin layer 140 can also be referred to as a “thermoplastic resin adhesive layer” or the like.

As described above, the top cover 150 of the safety valve is electrically connected to one of the positive electrode and the negative electrode of the battery assembly with the safety cover 110, the stripper disk 130, and the conductive member 15 interposed therebetween. On the other hand, the other electrode is electrically connected to the exterior body 50. For example, the top cover 150 of the safety valve may function as a positive electrode terminal of the battery, and the exterior body 50 including the cylindrical portion 52 and the support portion 54 may function as a negative electrode terminal. Thus, the conductive member (in particular, the top cover 150, the safety cover 110, and the stripper disk 130) of the safety valve 100 may be insulated from the exterior body 50. The exterior body 50 and the safety valve 100 may be insulated from each other with the insulating thermoplastic resin layer 140 being interposed therebetween. In other words, the exterior body 50 and the safety valve 100 may be insulated from each other by the thermoplastic resin layer 140 interposed between the support portion 54 and the safety valve 100. That is, the thermoplastic resin layer 140 can contribute to insulation between the safety valve 100 and the support portion 54 (exterior body) in addition to adhesion between the safety valve 100 and the support portion 54.

As illustrated in FIG. 5, according to the battery of the present application, the safety valve 100 is disposed outside the exterior body 50. Thus, the battery of the present application does not require a space for disposing the safety valve 100 inside the exterior body 50. Therefore, a larger battery assembly can be disposed inside the exterior body 50, and the internal volume of the electrode can be effectively used. This makes it possible to further improve the energy density of the battery.

In an embodiment, the safety cover 110 includes an outer peripheral region 110Y extending outward with respect to the stripper disk 130 in the radial direction. The “radial direction” is a radial direction of the cylindrical portion 52 of the exterior body, and means a direction orthogonal to the battery axis P. That is, the diameter dimension of the safety cover 110 may be larger than the diameter dimension of the stripper disk 130 in plan view. The support portion 54 may be adhered to the safety cover 110 of the safety valve with the thermoplastic resin layer 140 interposed therebetween. More specifically, the support portion 54 may overlap the outer peripheral region 110Y of the safety cover 110 extending outward in the radial direction with respect to the stripper disk 130 in the battery axis P direction, and the support portion 54 and the outer peripheral region 110Y may be adhered to each other with the thermoplastic resin layer 140 interposed therebetween. As described above, the stripper disk 130 is positioned relatively on the inner side with respect to the safety cover 110 in the battery axis P direction. Thus, adopting a structure in which the support portion 54 and the safety cover 110 are adhered to each other makes it possible to dispose the stripper disk 130 relatively on the inner side of the exterior body 50. As a result, the distance between the stripper disk 130 and the battery assembly disposed in the exterior body can be shortened, thus the space between the safety valve 100 and the battery assembly can be reduced, and the battery can be further downsized.

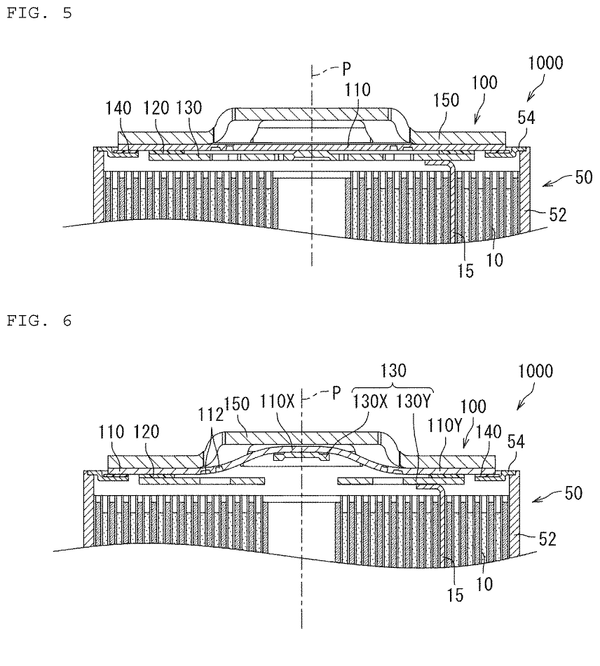

Next, an operation mechanism of the safety mechanism according to the battery of the present application will be described with reference to the drawings. FIGS. 6 and 7 are schematic views for describing a safety mechanism resulting from breakage and/or cleavage in the stripper disk 130 and the safety cover 110 constituting the safety valve 100.

For example, when gas is generated inside the exterior body 50 because of a side reaction such as a decomposition reaction of an electrolytic solution accompanying overcharge, the gas is accumulated inside the exterior body 50, and the internal pressure of the exterior body 50 increases. When the internal pressure of the exterior body 50 continues to increase, the stripper disk 130 and the safety cover 110 are affected by the increase in the internal pressure. When the internal pressure of the exterior body 50 exceeds a predetermined pressure, the central region 110X of the safety cover is pushed up and displaced toward the outside of the battery along the battery axis P direction as illustrated in FIG. 6. With such displacement, the central region 130X of the stripper disk 130 is also pushed up in the displacement direction, and breaks starting from the groove portion 132 provided in the stripper disk 130. In the present specification, “breaking” means that the connection is fully cut off. This causes the stripper disk 130 to be divided into the central region 130X on the inner peripheral side with respect to the groove portion 132 and the non-central region 130Y on the outer peripheral side with respect to the groove portion 132. More specifically, the stripper disk 130 is divided into the central region 130X connected to the safety cover 110 and the non-central region 130Y connected to the conductive member 15. As can be seen from the configuration illustrated in FIG. 6, such division physically separates the safety cover 110 and the non-central region 130Y of the stripper disk from each other. Thus, the electrical connection between the top cover 150 and the battery assembly is cut off, and the current path flowing between the top cover 150 and the battery assembly is cut off. In this manner, it is possible to cut off the current of the battery when the internal pressure has abnormally increased.

When the displacement of the safety cover 110 further progresses because of the internal pressure after the above-described cutoff mechanism has operated, the safety cover 110 may be cleaved or break starting from the groove portion 132 provided in the safety cover 110 (see FIG. 7). The term “cleavage” in the present specification includes a form in which at least a part is divided while a part is continuous. That is, in the safety cover 110, the central region 110X on the inner peripheral side of the groove portion 112 and the non-central region 110Y on the outer peripheral side of the groove portion 112 do not have to be fully separated, or they may be fully separated. When the safety cover 110 is cleaved, the gas inside the exterior body 50 is released to the outside from the cleaved portion, and the internal pressure decreases. In such a case, the gas release path through the plurality of openings 154 formed in the top cover 150 is released, and the gas can be released to the outside of the battery through the openings. In an embodiment, the stripper disk 130 also includes an opening 134, and the gas inside the exterior body 50 may be released to the outside through the stripper disk 130.

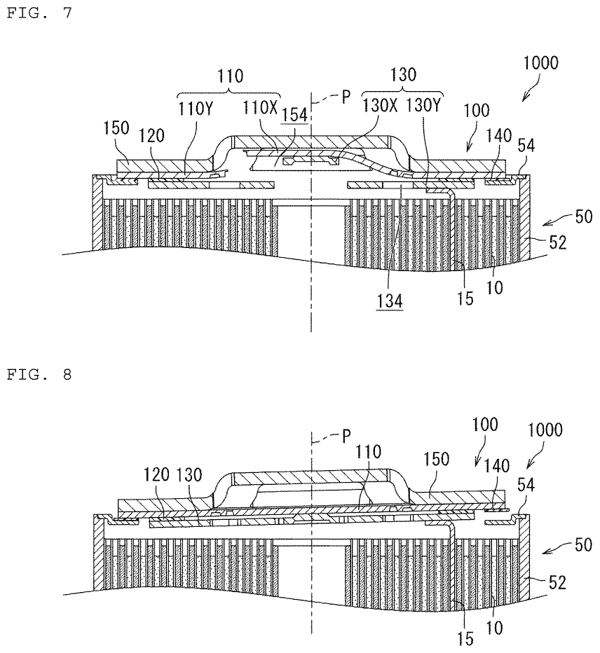

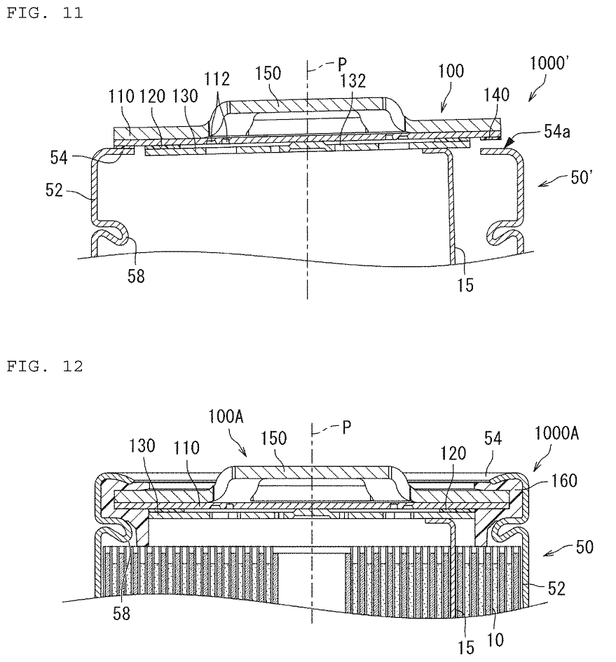

As described above, factors that increase the pressure inside the battery include an overcharged state of the battery and an abnormally high temperature state of the battery. The battery of the present application has a structure capable of suitably releasing the internal pressure of the battery not only when the battery is in an overcharged state but also when the battery is in an abnormally high temperature state. FIG. 8 is a sectional view schematically illustrating the battery of the present application in an abnormally high temperature state. FIG. 11 is a sectional view schematically illustrating an aspect in which the exterior body includes a beading portion in the battery of the present application in an abnormally high temperature state. In the present application, the “abnormally high temperature state” means a state in which gas is abnormally generated inside the battery because of an increase in the temperature inside the battery. For example, the “abnormally high temperature state” may be a state in which the temperature of the outer surface of the battery is 100° C. or higher. In the abnormally high temperature state, the thermoplastic resin layer 140 contributing to adhesion between the support portion 54 and the safety valve 100 is softened because of the high temperature. This decreases the adhesive force between the support portion 54 and the safety valve 100 with the thermoplastic resin layer 140. On the other hand, when the internal pressure of the exterior body 50 is increased by the gas generated inside the exterior body 50 because of the abnormally high temperature state, a force pressing the outer side of the battery in the battery axis P direction may act on the safety valve 100. When the pressing force acts on the safety valve 100 in a state where the adhesive force of the thermoplastic resin layer 140 is reduced, the safety valve 100 is detached from the support portion 54 of the exterior body, and the gas can be released to the outside from the opening 56 of the exterior body. This suitably reduces the internal pressure of the exterior body 50. The internal pressure of the battery can be released in this manner when the internal pressure of the exterior body 50 has increased because of the abnormally high temperature state. Such a mechanism for releasing gas caused by high temperature can also be understood as, for example, a degassing mechanism accompanied by thermal cleavage between the safety valve 100 and the support portion 54, and thus is hereinafter also simply referred to as a “thermal cleavage mechanism”.

As described above, the battery of the present application includes a degassing mechanism (thermal cleavage mechanism) accompanying softening of the thermoplastic resin layer 140 in an abnormally high temperature state, in addition to the current cutoff mechanism accompanying breakage of the stripper disk 130 and the degassing mechanism accompanying cleavage of the safety cover 110 of the safety valve. In the degassing mechanism using the safety cover 110, degassing is performed through breakage of the stripper disk 130 and cleavage of the safety cover 110. On the other hand, in the thermal cleavage mechanism, in an abnormally high temperature state, an adhered portion between the exterior body 50 and the safety valve 100 with the thermoplastic resin layer 140 interposed therebetween is peeled off, and thus degassing can be immediately performed.

Further, according to the structure of the present application, since the safety valve 100 is disposed in such a manner as to overlap the support portion 54 in the direction of the battery axis P, the safety valve does not receive a pressure from the radial direction as illustrated in the conventional crimping structure (FIG. 12). Thus, when the internal pressure of the exterior body 50 has increased, the safety valve 100 can be easily peeled off from the support portion 54. Further, since the safety valve 100 is positioned on the outer side with respect to the support portion 54 in the battery axis P direction, when the internal pressure of the exterior body 50 has increased, the safety valve 100 can be suitably peeled off from the support portion 54 without being blocked by other members.

The thermoplastic resin layer 140 contributes to sealing between the support portion 54 and the safety valve 100 in a non-abnormally high temperature state (for example, a state where the temperature of the battery is in a temperature range of 25° C. or higher and lower than 100° C.) including a normal state. That is, in the normal state, the exterior body 50 may be sealed by the safety valve 100 and the thermoplastic resin layer 140 interposed between the safety valve 100 and the exterior body 50. As a result, when the internal pressure has increased because of overcharge or the like while the battery is in a non-abnormally high temperature state, it is possible to break the stripper disk 130 using the increase in the internal pressure and cut off the current path. That is, in an abnormally high temperature state, the degassing mechanism accompanied by thermal cleavage in the thermoplastic resin layer 140 operates, but on the other hand, in an abnormal state (for example, an overcharged state) of the battery except for an abnormally high temperature state, the cutoff mechanism of the current path can be operated before the thermal cleavage mechanism operates.

The thermoplastic resin layer 140 disposed between the support portion 54 and the safety valve 100 contains a thermoplastic resin. When resistance to an electrolytic solution is emphasized, the thermoplastic resin layer 140 preferably contains a crystalline thermoplastic resin. For example, the thermoplastic resin layer 140 may contain at least one resin selected from super engineering plastic-based resins and polyolefin-based resins. Examples of the super engineering plastic-based resin include polyetheretherketone (PEEK), polyamideimide (PAI), polyphenylene sulfide (PPS), polyetherimide (PEI), polyetherketoneketone (PEKK), polyethylene naphthalate (PEN), super engineering plastic polysulfone (PSU), polyethersulfone (PES), polyarylate (PAR), polyamideimide (PAI), polyimide (PI), polybenzimidazole (PBI), polytetrafluoroethylene (PTFE), polychlorotrifluoroethylene (PCTFE), Neoflon (PFA), Fluon, Neoflon (ETFE), and polyvinylidene fluoride (PVDF). Examples of the polyolefin-based resin include polyolefin resins such as polyethylene, polypropylene, polymethylpentene, polybutene, ethylene-propylene copolymer, ethylene-α-olefin copolymer, and propylene-α-olefin copolymer, and polyolefin-based resins such as olefin-based copolymer resins, for example, ethylene-vinyl acetate copolymer, ethylene-vinyl alcohol copolymer, ethylene-(meth)acrylic acid (ester) copolymer, and ethylene-unsaturated carboxylic acid copolymer metal neutralized product (ionomer). Since the thermoplastic resin layer 140 contains the thermoplastic resin as described above, the thermoplastic resin layer is suitably softened when the battery is in an abnormally high temperature state, and it may be possible to thermally cleave between the support portion 54 and the safety valve 100.

The melting point of the thermoplastic resin layer 140 may be 320° C. or lower, 340° C. or lower, 350° C. or lower, or 360° C. or lower. When the melting point is in the above-described range, thermal cleavage is more suitably performed in an abnormally high temperature state, and a battery having more excellent safety can be obtained. When it is emphasized that the thermoplastic resin layer 140 appropriately adheres and seals a space between the safety valve 100 and the exterior body 50 in a non-abnormally high temperature state, the melting point of the thermoplastic resin layer 140 may be, for example, 80° C. or higher.

As described above, factors that increase the pressure inside the battery include an overcharged state of the battery and an abnormally high temperature state of the battery. All of these cases are accompanied by the abnormal generation of gas inside the exterior body 50, but the inventors of the present application have found that the safety mechanisms to be prioritized in the overcharged state and the abnormally high temperature state may be different from each other. For example, when the battery is in an overcharged state, the potential of the positive electrode increases, whereby the electrolytic solution is oxidatively decomposed, and a chemical reaction accompanied by gas generation occurs. Thus, it is preferable that the progress of the battery reaction is suppressed by cutting of the current path, and then the internal pressure is released by degassing. On the other hand, in an abnormally high temperature state, an undesirable side reaction occurs in the thermally unstable battery material because of the high temperature, and gas may be generated. Since the abnormally high temperature state is an abnormal state caused by thermal energy applied to the battery and is different from an abnormal state caused by electric energy such as an overcharged state, the degassing mechanism may be required to operate preferentially rather than the cutoff mechanism of the current path.

The battery of the present application includes a thermal cleavage mechanism with the thermoplastic resin layer 140 between the support portion 54 of the exterior body and the safety valve 100, and a breaking/cleavage mechanism of a member constituting the safety valve 100. Since these safety mechanisms all use the increased internal pressure inside the exterior body 50, which safety mechanism among the plurality of safety mechanisms functions preferentially may depend on a difference in pressure required to operate the safety mechanism. The inventors of the present application have achieved a battery capable of selectively operating an appropriate safety mechanism according to a situation by controlling the pressure required for operating the safety mechanism in each safety mechanism.

The pressure Pt (hereinafter, also referred to as “resin fixing pressure”, “resin adhesion pressure”, “resin layer peeling pressure”, or “thermal cleavage pressure”) required for peeling off the adhesion between the safety valve 100 and the support portion 54 with the thermoplastic resin layer 140 varies depending on the temperature. Specifically, since the thermoplastic resin layer 140 is softened at a high temperature and the adhesive strength (or fixing strength) decreases, the resin fixing pressure Pt decreases as the temperature increases. In other words, the resin fixing pressure Pt may be higher under low temperature conditions. By designing the resin fixing pressure in a normal state, the resin fixing pressure in an abnormally high temperature state, and the pressure required for the breakage of the groove portion 132 of the stripper disk of the safety valve to have any magnitude relationship based on such matters, it is possible to realize the operation of the safety mechanism according to the status of the battery.

For example, in a normal state, the pressure Ps (hereinafter, also referred to as “safety valve cutoff pressure” or “stripper disk breaking pressure”) required for breaking the groove portion 132 of the stripper disk of the safety valve is smaller than the resin fixing pressure Pt of the thermoplastic resin layer. In other words, in a non-abnormally high temperature state including a normal state, the fixing strength between the safety valve 100 and the support portion 54 with the thermoplastic resin layer 140 may be larger than the safety valve breaking pressure Ps. In the normal state, since the relationship between the safety valve cutoff pressure Ps and the resin fixing pressure Pt is Ps<Pt, the cutoff mechanism of the current path in the stripper disk 130 operates earlier than the thermal cleavage mechanism in the thermoplastic resin layer 140 in the normal state. That is, in the normal state, before the safety valve 100 is peeled off from the support portion 54 in the thermoplastic resin layer 140 and degassing is performed, the groove portion 132 of the stripper disk breaks, and the current path of the battery is cut off.

On the other hand, in the abnormally high temperature state, the resin fixing pressure Pt of the thermoplastic resin layer is smaller than the safety valve cutoff pressure Ps. In other words, in the abnormally high temperature state, the safety valve breaking pressure Ps may be larger than the fixing strength between the safety valve 100 and the support portion 54 with the thermoplastic resin layer 140. Since the relationship between the safety valve cutoff pressure Ps and the resin fixing pressure Pt satisfies Ps>Pt in the abnormally high temperature state, the thermal cleavage mechanism in the thermoplastic resin layer 140 operates earlier than the cutoff mechanism of the current path in the stripper disk 130 in the abnormally high temperature state. That is, in the normal state, the safety valve 100 is peeled off from the support portion 54 in the thermoplastic resin layer 140 before the groove portion 132 of the stripper disk breaks and the current path of the battery is cut off, and degassing is performed.

As described above, the present application may provide a battery in which the cutoff path of the current path preferentially can operate in a non-abnormally high temperature state, and the degassing mechanism can preferentially operate in an abnormally high temperature state. That is, according to the present application, a more reliable battery capable of selectively operating a more appropriate safety mechanism according to the state of the battery can be provided.

The resin fixing pressure Pt at any temperature can be obtained by measurement using an adhesive assembly in which the support portion 54 and the safety valve 100 are adhered using the thermoplastic resin layer 140. Specifically, the pressure can be obtained by applying a force to the safety valve 100 of the adhesive assembly from the inner side to the outer side of the exterior body 50 under any temperature condition, and measuring the pressure when the safety valve 100 is peeled off from the support portion 54.

In addition, the inventors of the present application have newly found that the temperature dependence of the resin fixing pressure Pt of the thermoplastic resin layer 140 as described above can satisfy the relationship represented by the following Formula 1.

$${Pt}_{1} = {Pt}_{2} - \frac{{Pt}_{2}}{{T}_{m} - {T}_{2}} ( {T}_{1} - {T}_{2} ) \qquad [ Formula 1 ]$$

In the formula, Pt₁ is the resin fixing pressure at the temperature T₁, Pt₂ is the resin fixing pressure at the temperature T₂, Tₘ is the melting point of the thermoplastic resin layer 140, and T₁>T₂ is satisfied. Measuring the resin fixing pressure Pt at a certain temperature based on Formula 1 makes it possible to obtain the resin fixing pressure Pt at any temperature. That is, the resin fixing pressure Pt at any temperature may be determined by measurement, and alternatively, the resin fixing pressure Pt₂ at a predetermined certain temperature T₂ may be determined by measurement, and the resin fixing pressure Pt₁ at any temperature T₁ may be obtained based on Formula 1 using the resin fixing pressure Pt₂ obtained by measurement.

The resin fixing pressure Pt at a certain temperature can be controlled by the material of the thermoplastic resin layer 140, the thickness dimension of the thermoplastic resin layer 140, the width dimension of the thermoplastic resin layer 140 in plan view, and/or the adhesion area between the support portion 54 and the safety valve 100. The safety valve cutoff pressure Ps can also be controlled according to the material of the stripper disk 130 and/or the shape of the groove portion 132. When emphasis is placed on causing the battery to fail more safely in both the overcharged state and the abnormally high temperature state, it is preferable that the current path can be cut off earlier in the overcharged state, and thermal cleavage can be performed earlier in the abnormally high temperature state. According to the present application, it is possible to appropriately change the material and adhesion area of the thermoplastic resin layer 140 so that the resin fixing pressure in the abnormally high temperature state has a value lower than the safety valve cutoff pressure while designing the safety valve cutoff pressure to be a lower value. This may result in a battery having more excellent safety capable of selectively activating an appropriate safety mechanism depending on the state of the battery.

A method for producing a battery according to an embodiment of the present application will be exemplarily described by employing a method for producing a secondary battery as an example. The secondary battery of the present application can be produced by the following procedure, for example.

In the production of a positive electrode, first, a positive electrode active material is, as necessary, mixed with a positive electrode binder, a positive electrode conductive agent, and the like to obtain a positive electrode mixture. Subsequently, the positive electrode mixture is dispersed in, for example, an organic solvent to obtain a positive electrode mixture slurry in a paste form. Then, a positive electrode active material layer is formed by applying the positive electrode mixture slurry to one or both surfaces of a positive electrode current collector and drying the positive electrode mixture slurry. Thereafter, the positive electrode active material layer may be compression-molded using a roll press or the like, as necessary. In such a case, the cathode active material layer may be heated, or compression molding may be repeated multiple times. In the same manner, a negative electrode can be produced. Specifically, a negative electrode active material, and, for example, a negative electrode binder and the negative electrode conductive agent are mixed to obtain a negative electrode mixture. Subsequently, the negative electrode mixture is dispersed in, for example, an organic solvent to obtain a negative electrode mixture slurry in a paste form. Next, a negative electrode active material layer is formed by applying the negative electrode mixture slurry to one or both surfaces of the negative electrode current collector and then drying the negative electrode mixture slurry. Thereafter, the negative electrode active material layer is compression-molded using a roll press or the like, as necessary.

When the secondary battery is assembled, a positive electrode lead is connected to the positive electrode current collector by a welding method and the like and the negative electrode lead is also connected to the negative electrode current collector by a welding method and the like. Next, the positive electrode and the negative electrode are stacked with the separator interposed therebetween, and then, the positive electrode, the negative electrode, and the separator are wound to form a wound electrode body. Next, a center pin is inserted in a winding space of the wound electrode body. Then, the wound electrode body is sandwiched between a pair of insulating plates, and is contained inside an exterior body together with the pair of insulating plates. In this case, one end of the positive electrode lead is connected to the safety valve by, for example, a welding method, and one end of the negative electrode lead is connected to the exterior body by, for example, a welding method. Next, an electrolytic solution is injected into the exterior body to impregnate the wound electrode body with the electrolytic solution. Finally, the exterior body is provided with a support portion, and a safety valve is fixed on the support portion with a thermoplastic resin layer interposed therebetween. A secondary battery provided with a safety valve is thus completed.

Although one or more embodiments of the present application have been described including examples have been illustrated. Those skilled in the art will readily understand that the present application is not limited thereto, and various embodiments are conceivable without changing the scope of the present application.

It is to be noted that the present disclosure as described above encompasses the following aspects according to an embodiment.

<1>

A battery including:
an exterior body that houses a battery assembly and an electrolyte; and
a safety valve attached to the exterior body, wherein the battery assembly includes a positive electrode, a negative electrode, and a separator,
the exterior body includes a cylindrical portion, a support portion protruding inward from the cylindrical portion at one end portion of the cylindrical portion, and an opening surrounded by the support portion,
the safety valve is positioned at the one end portion of the cylindrical portion, and
the safety valve and the support portion are fixed to each other with a thermoplastic resin layer interposed therebetween.

<2>

The battery according to <1>, wherein
the support portion includes an outer main surface positioned on an outer side of the exterior body,
the safety valve is positioned on an outer main surface of the support portion, and
the thermoplastic resin layer is interposed between the outer main surface and the safety valve.

<3>

The battery according to <1> or <2>, wherein the thermoplastic resin layer seals a space between the safety valve and the support portion in a normal state.

<4>

The battery according to any one of <1> to <3>, wherein
the safety valve includes a first metal member positioned relatively on an outer side of the battery and a second metal member positioned relatively on an inner side of the battery, and
the second metal member includes a groove portion cleavable with an internal pressure of the exterior body.

<5>

The battery according to <4>, wherein
the first metal member includes an outer peripheral portion extending outward with respect to the second metal member in a radial direction, and
the support portion overlaps the outer peripheral portion with the thermoplastic resin layer interposed therebetween.

<6>

The battery according to <4> or <5>, wherein the safety valve is provided on the exterior body with the thermoplastic resin layer disposed between the first metal member and the support portion.

<7>

The battery according to any one of <4> to <6>, wherein a solid pressure of the thermoplastic resin layer is larger than a cutoff pressure in the groove portion of the second metal member in a normal state.

<8>

The battery according to any one of <4> to <7>, wherein a solid pressure of the thermoplastic resin layer is smaller than a cutoff pressure in the groove portion of the second metal member in an abnormally high temperature state.

<9>

The battery according to any one of <1> to <8>, wherein a solid pressure of the thermoplastic resin layer is lower than an internal pressure of the exterior body in an abnormally high temperature state.

<10>

The battery according to any one of <1> to <9>, wherein the thermoplastic resin layer has a melting point of 80° C. or more and 340° C. or less.

<11>

The battery according to any one of <1> to <10>, wherein the thermoplastic resin layer contains a polyolefin-based resin.

<12>

The battery according to any one of <1> to <11>, wherein the cylindrical portion of the exterior body has a structure not including a beading portion.

### EXAMPLES

Hereinafter, the present application will be described in further detail including with reference to Examples. The present application is not limited by the following Examples.

### [Test Battery]

A secondary battery having the following specifications was prepared.
Shape: cylindrical shape (diameter dimension: about 22 mm, axial length: about 70 mm)
Positive electrode and negative electrode of battery assembly: positive electrode and negative electrode capable of occluding and releasing lithium ion
Nominal capacity: about 4100 mAh
Nominal voltage: 3.6 V
Safety valve: valve configuration in which top cover, safety cover, insulating member, and stripper disc are combined in this order

### (Material of Each Member)

Safety cover: made of metal (metal containing aluminum)
Insulating member: made of resin (epoxy resin)
Stripper disk: made of metal (metal containing aluminum)
Thermoplastic resin layer: made of resin (polypropylene (PP) or polyphenylene sulfide (PPS))
Exterior body (support portion and cylindrical portion): made of metal (metal containing iron)

### Examples 1 to 6

Examples 1 to 6 had the same conditions except that the cutoff pressure (safety valve cutoff pressure) Ps of the stripper disk, the material of the thermoplastic resin layer, the resin fixing pressure Pt_{23° C.} in a non-abnormally high temperature state (23° C.), and the resin fixing pressure Pt_{100° C.} in an abnormally high temperature state (100° C.) were different from each other. The safety valve cutoff pressure Ps was varied by changing the thickness of the stripper disk. The resin fixing pressure Pt was varied by changing the material or changing the fixing area of the thermoplastic resin layer. The batteries of Examples 1 to 6 were batteries having a structure not including the beading portion illustrated in FIG. 5.

### Comparative Examples 1 to 3

Comparative Example 1 corresponds to a battery having a conventional structure including a safety valve fixed by applying a pressure in a radial direction via a gasket in an exterior body having a beading portion (corresponding to the structure of FIG. 12). Comparative Example 2 corresponds to a battery that does not include a current path cutoff mechanism. More specifically, the battery corresponds to a battery in which a plate-shaped plate terminal having no groove portion is adhered on a support portion of an exterior body with a thermoplastic resin layer interposed therebetween, and an opening is closed by the plate terminal. Comparative Example 3 corresponds to a battery in which the thermoplastic resin layer is positioned on the inner main surface 54b of the main surface of the support portion, the inner main surface facing the inside of the exterior body (corresponding to the structure of FIG. 13). That is, in the battery of Comparative Example 3, the safety valve is positioned on the inner side with respect to the support portion in the battery axial direction.

For each of the batteries of Examples 1 to 6 and Comparative Examples 1 to 3, the safety valve cutoff pressure, the resin fixing pressure in a normal state (23° C.), and the resin fixing pressure in an abnormally high temperature state (100° C.) were measured. In addition, for each battery, an overcharge test based on the Electrical Appliances and Materials Safety Act and a UL Projectile test (burner heating test) conforming to the UL1642 standard were performed.

### (Measurement of Safety Valve Cutoff Pressure)

The safety valve cutoff pressure was measured by the following method. A constant current was applied to the safety cover and the stripper disc of the safety valve by external connection. In this state, after pressurization was performed at a pressurization speed of 0.33 kgf/cm²/sec using a hydraulic pressurization device, the pressure at the time when the current stopped flowing was defined as the cutoff pressure.

### (Measurement of Resin Fixing Pressure)

In the measurement of the resin fixing pressure, a hole was made in the exterior body including the safety valve, the internal pressure of the exterior body was increased at a pressure increasing rate of 0.33 kgf/cm²/sec using a hydraulic pressure increasing device through the hole, and the pressure at the time when the hydraulic pressure was released was taken as the resin fixing pressure. The measurement was performed under each condition where the temperature of the outer surface of the battery was 23° C. and 100° C., and the resin fixation pressure at 23° C. and 100° C. was determined.

### (Overcharge Test)

While the temperature of the battery was measured, the battery in a fully discharged state was charged at a constant current of 1.0 ItA to 250% of the nominal capacity using a charge power supply voltage of 18 V, and forcibly brought into an overcharged state. When the current path was cutoff (that is, when the current stopped flowing) because of the operation of the safety mechanism provided in the battery, the test was stopped at that time. It can be understood that the lower the maximum attainment temperature in the test, the earlier the safety mechanism is operated, and the abnormal heat generation of the battery is suitably suppressed. Thus, when the highest attainment temperature was 110° C. or less, the battery was evaluated as Best, when the highest attainment temperature was 130° C. or less, the battery was evaluated as Good, and when the highest attainment temperature was more than 130° C., the battery was evaluated as Poor.

### (Heating Test)

The fully charged battery was fixed on a heating table with a wire. The periphery of the battery was covered with an octagonal aluminum 17 mesh net, the battery was heated with a burner from below the heating table, and the heating was continued until the battery was ignited or ruptured. A battery member that was ignited or ruptured after the end of the test and did not come out of the aluminum 17 mesh net was determined as Pass, and a battery member that was ruptured and came out of the mesh net was determined as Fail.

From each test result, comprehensive evaluation was performed according to the following criteria.
⊙: Overcharge test result was “Best” and heating test result was “Pass”
◯: Overcharge test result was “Good” and heating test result was “Pass”
X: Overcharge test result was “Poor” or heating test result was “Fail”

The results are shown in Table 1 below.

TABLE 1

| | Safety | Thermoplastic resin layer | | |
|---|---|---|---|---|
| | valve | | Fixing | Fixing |
| | Safety | | pressure | pressure |
| | valve | | Pt_{23° C.} at | Pt_{100° C.} at |
| | cutoff | | temperature | temperature |
| | pressure | Thermoplastic | 23° C. | 100° C. |
| | (kgf/cm2) | resin | (kgf/cm2) | (kgf/cm2) |
| Example 1 | 15 | PP | 31 | 12 |
| Example 2 | 14 | PP | 23 | 9 |
| Example 3 | 16 | PP | 24 | 10 |
| Example 4 | 18 | PPS | 25 | 17 |
| Example 5 | 12 | PP | 20 | 8 |
| Example 6 | 16 | PP | 14 | 6 |
| Comparative | 15 | — | — | — |
| Example 1 | | | | |
| Comparative | — | — | 30 | 12 |
| Example 2 | | | | |
| Comparative | 15 | PP | 31 | 12 |
| Example 3 | | | | |

| | Test results | | | |
|---|---|---|---|---|
| | Maximum | | | |
| | attainment | | | |
| | temperature | | | |
| | of battery in | Overcharge | UL | |
| | overcharge test | test | Projectile | Comprehensive |
| | (° C.) | evaluation | test | evaluation |
| Example 1 | 93 | Best | Pass | ⊙ |
| Example 2 | 88 | Best | Pass | ⊙ |
| Example 3 | 97 | Best | Pass | ⊙ |
| Example 4 | 100 | Best | Pass | ⊙ |
| Example 5 | 78 | Best | Pass | ⊙ |
| Example 6 | 130 | Good | Pass | ◯ |
| Comparative | 95 | Best | Fail | X |
| Example 1 | | | | |
| Comparative | 135 | Poor | Pass | X |
| Example 2 | | | | |
| Comparative | 94 | Best | Fail | X |
| Example 3 | | | | |

From the results in Table 1, in the batteries of Comparative Examples 1 and 3 in which the safety valve is held inside the exterior body with a gasket or a thermoplastic resin layer interposed therebetween, the current path was cut off in the overcharged state, but the degassing was insufficient in the abnormally high temperature state, and the battery failed in the UL Projectile test. On the other hand, in the batteries of Examples 1 to 6 in which the safety valve was disposed on the outer side of the exterior body and the exterior body and the safety valve were fixed using a thermoplastic resin, it was possible to more safely cause the battery to fail in the overcharged state and the abnormally high temperature state. Thus, it was found that the present application provides a battery including a structure more suitable as a safety valve, which can suitably perform degassing not only when the internal pressure has abnormally increased in a non-abnormally high temperature state such as overcharge but also in an abnormally high temperature state.

As compared with the battery of Example 6 in which the resin fixing pressure in the non-abnormally high temperature state (23° C.) was smaller than the safety valve cutoff pressure, more excellent results were obtained in the overcharge test in the batteries of Examples 1 to 5 in which the resin fixing pressure in the non-abnormally high temperature state was larger than the safety valve cutoff pressure. This is because, in the batteries of Examples 1 to 5, in the overcharged state, the cutoff mechanism of the current path with the safety valve was operated to suitably stop charging, and in the abnormally high temperature state, the thermal cleavage mechanism in the thermoplastic resin layer was operated. From this result, it was found that a more reliable battery capable of selectively operating a more suitable safety mechanism when the internal pressure of the exterior body has increased in the non-abnormally high temperature state (for example, in the overcharged state) and in the abnormally high temperature state can be obtained by making the resin fixing pressure in the non-abnormally high temperature state larger than the safety valve cutoff pressure and making the resin fixing pressure in the abnormally high temperature state smaller than the safety valve cutoff pressure.

The effects and the like of the above-described Examples are merely one example. Therefore, the present application is not limited thereto, and may have an additional effect.

The battery (battery such as a primary battery and a secondary battery) according to the present application can be typically used for applications in which use of electric energy is required. For example, the secondary battery according to the present application can be used in various fields in which electric storage is assumed. As a mere example, the battery of the present application can be used in the fields of electricity, information, and communication in which electricity, electronic equipment, and the like are used (for example, electric and electronic equipment fields or mobile equipment fields including mobile phones, smartphones, notebook computers and digital cameras, activity meters, arm computers, electronic paper, wearable devices, and small electronic equipment such as RFID tags, card type electronic money, and smartwatches), home and small industrial applications (for example, the fields of electric tools, golf carts, and home, nursing, and industrial robots), large industrial applications (for example, the fields of forklift, elevator, and harbor crane), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (medical equipment fields such as earphone hearing aids), pharmaceutical applications (fields such as dosage management systems), IoT fields, space and deep sea applications (for example, the fields of a space probe and a submersible), and the like.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
an exterior body that houses a battery assembly and an electrolyte; and
a safety valve attached to the exterior body,
wherein the battery assembly includes a positive electrode, a negative electrode, and a separator,
the exterior body includes a cylindrical portion, a support portion protruding inward from the cylindrical portion at one end portion of the cylindrical portion, and an opening surrounded by the support portion,
the safety valve is positioned at the one end portion of the cylindrical portion, and
the safety valve and the support portion are fixed to each other with a thermoplastic resin layer interposed therebetween.

2. The battery according to claim 1, wherein
the support portion includes an outer main surface positioned on an outer side of the exterior body,
the safety valve is positioned on an outer main surface of the support portion, and
the thermoplastic resin layer is interposed between the outer main surface and the safety valve.

3. The battery according to claim 1, wherein the thermoplastic resin layer seals a space between the safety valve and the support portion in a normal state.

4. The battery according to claim 1, wherein
the safety valve includes a first metal member positioned relatively on an outer side of the battery and a second metal member positioned relatively on an inner side of the battery, and
the second metal member includes a groove portion cleavable with an internal pressure of the exterior body.

5. The battery according to claim 4, wherein
the first metal member includes an outer peripheral portion extending outward with respect to the second metal member in a radial direction, and
the support portion overlaps the outer peripheral portion with the thermoplastic resin layer interposed therebetween.

6. The battery according to claim 4, wherein the safety valve is provided on the exterior body with the thermoplastic resin layer disposed between the first metal member and the support portion.

7. The battery according to claim 4, wherein a solid pressure of the thermoplastic resin layer is larger than a cutoff pressure in the groove portion of the second metal member in a normal state.

8. The battery according to claim 4, wherein a solid pressure of the thermoplastic resin layer is smaller than a cutoff pressure in the groove portion of the second metal member in an abnormally high temperature state.

9. The battery according to claim 1, wherein a solid pressure of the thermoplastic resin layer is lower than an internal pressure of the exterior body in an abnormally high temperature state.

10. The battery according to claim 1, wherein the thermoplastic resin layer has a melting point of 80° C. or more and 340° C. or less.

11. The battery according to claim 1, wherein the thermoplastic resin layer contains a polyolefin-based resin.

12. The battery according to claim 1, wherein the cylindrical portion of the exterior body has a structure not including a beading portion.
